(19) United States
(12) Patent Application Publication
(10) Pub. No.: US 2024/0055149 A1
(43) Pub. Date: Feb. 15, 2024

(54) SELF-BIASED 4H-SIC MOS DEVICES FOR RADIATION DETECTION

(71) Applicant: University of South Carolina, Columbia, SC (US)

(72) Inventors: Krishna C. Mandal, Columbia, SC (US); Sandeep K. Chaudhuri, Columbia, SC (US)

(73) Assignee: University of South Carolina, Columbia, SC (US)

(21) Appl. No.: 18/330,749

(22) Filed: Jun. 7, 2023

Related U.S. Application Data
(60) Provisional application No. 63/395,900, filed on Aug. 8, 2022.

(51) Int. Cl. G21H 1/06; G01T 1/24

(52) U.S. Cl. CPC G21H 1/06; G01T 1/24

(57) ABSTRACT

Described herein are methods and systems for fabrication of high-performing metal-oxide-semiconductor (MOS) devices by depositing yttrium oxide epitaxial layers through pulsed laser deposition on high quality 4H—SiC epitaxial layers. The novel MOS devices revealed an extraordinarily long hole diffusion length that has never been reported. These devices have been investigated as radiation detectors which demonstrated an excellent radiation response at zero applied bias (self-biased) with a record-high energy resolution.

### STATEMENT REGARDING FEDERALLY SPONSORED RESEARCH

This invention was made with government support under DOE-NEUP grant DE-NE0008662 and DE-AC07-051D14517. The government has certain rights in the invention.

### TECHNICAL FIELD

The subject matter disclosed herein is generally directed to methods and systems for fabrication of high-performing metal-oxide-semiconductor (MOS) devices by depositing yttrium oxide epitaxial layers through pulsed laser deposition on high quality 4H—SiC epitaxial layers. The novel MOS devices revealed an extraordinarily long hole diffusion length that has never been reported. These devices have been investigated as radiation detectors which demonstrated an excellent radiation response at zero applied bias (self-biased) with a record-high energy resolution.

### BACKGROUND

The need exists for high performing, self-biased radiation detectors fabricated intended for applications in harsh environment space missions, wherein carrying detector power supplies as payload becomes a critical logistics issue. Accordingly, it is an object of the present disclosure to provide methods and systems for fabrication of high-performing metal-oxide-semiconductor (MOS) devices to provide a new host of radiation detectors that meet these needs as well as other industrial needs.

Citation or identification of any document in this application is not an admission that such a document is available as prior art to the present disclosure.

### SUMMARY

The above objectives are accomplished according to the present disclosure by providing in one instance, a betavoltaic cell for power generation in harsh environment applications. The cell may include at least one metal-oxide-semiconductor that may include at least one layer of yttrium oxide pulse laser deposited on at least one n-type 4H—SiC epilayer, at least one first nickel contact, deposited on the at least one yttrium oxide layer, configured to act as a gate contact, and at least one second nickel contact formed on the at least one n-type 4H—SiC epilayer as a back contact. Further, the betavoltaic cell may be mounted on a printed circuit board. Still yet, the betavoltaic cell may be heteroepitaxial. Again, the betavoltaic cell may have reduced dark current as compared to a Schottky barrier diode fabricated on at least one 4H—SiC epilayer. Moreover, the betavoltaic cell may have less surface recombination velocity as compared to a Schottky barrier diode fabricated on at least one 4H—SiC epilayer. Even further, the betavoltaic cell may have at least a maximum power density output of 11 nW/cm³. Still yet, the betavoltaic cell may have at least a fill factor of 66% when exposed to a 2.5 mCi ⁶³Ni beta particle emitter. Even further, the betavoltaic cell may include a 4H—SiC buffer layer. Further again, the betavoltaic cell may include a depletion layer edge.

The present disclosure may also provide a method for making a betavoltaic cell for power generation in harsh environment applications. The method may include forming at least one vertical metal-oxide-semiconductor via growing at least one layer of yttrium oxide, via pulsed laser deposition, on at least one n-type 4H—SiC epilayer, depositing at least first one nickel contact on the at least one yttrium oxide layer configured to act as a gate contact, and depositing at least one second nickel contact on the at least one n-type 4H—SiC epilayer to form a back contact. Further, the method may include mounting the betavoltaic cell on a printed circuit board. Still further, the method may include configuring the betavoltaic cell to be heteroepitaxial. Even further, the method may include configuring the betavoltaic cell to have reduced dark current as compared to a Schottky barrier diode fabricated on at least one 4H—SiC epilayer. Still yet, the method may include configuring the betavoltaic cell to have less surface recombination velocity as compared to a Schottky barrier diode fabricated on at least one 4H—SiC epilayer. Yet again, the method may include configuring the betavoltaic cell to have at least a maximum power density output of 11 nW/cm³. Even further, the method may include configuring the betavoltaic cell to have at least a fill factor of 66% when exposed to a 2.5 mCi ⁶³Ni beta particle emitter. Still yet further, the method may include configuring the betavoltaic cell to include a 4H—SiC buffer layer. Moreover, the method may include configuring the betavoltaic cell to include a depletion layer edge.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 shows at: (a) Schematic diagram of a Ni/Y₂O₃/4H—SiC epitaxial MOS detector; and at (b) a photograph of an 8 mm×8 mm detector mounted on a PCB for radiation spectroscopy measurements.

FIG. 2 shows at: (a) variation of current density with bias for a Ni/Y₂O₃/n-4H—SiC epitaxial MOS detector and a Ni/n-4H—SiC epitaxial SBD; (b) variation of specific capacitance with reverse bias; and (c)-(d) band diagrams calculated for the SBD and MOS interfaces, respectively.

FIG. 3 shows at: (a) variation of CCE with bias voltage; and at (b) a pulse height spectrum obtained by exposing the MOS detector to 5486 keV α-particles.

FIG. 4 shows an X-ray diffractogram obtained from a pulsed laser deposited 40 nm thick Y₂O₃ epilayer on a 20-μm thick n-type 4H—SiC epilayer.

FIG. 5 shows a schematic (not according to scale) of the Ni/Y₂O₃/4H—SiC MOS device configured as a betavoltaic cell.

FIG. 6 shows a photograph of a Ni/Y2O3/4H—SiC MOS betavoltaic cell source assembly.

FIG. 7 shows a graph of the dark current density-voltage (J-V) characteristics for the MOS device with 40 nm thick oxide layer compared with those obtained from a MOS device with 10 nm thick oxide layer and a Ni/4H—SiC SBD.

FIG. 8 shows a graph of the capacitance (per unit area)-voltage characteristics obtained for a Ni/Y₂O₃/4H—SiC MOS device with 40 nm thick oxide layer recorded using a test frequency of 1 MHz.

FIG. 9 shows a graph of the variation of CCE (triangles), measured with the Ni/Y₂O₃/4H—SiC MOS device configured as a radiation detector exposed to a ₂₄₁Am α-source, with negative gate bias.

FIG. 10 shows at: (a) J-V characteristics under dark and b-particle illumination of a Ni/Y₂O₃/4H—SiC MOS device with 40 nm thick oxide layer; and at (b) variation of current density (left y) and the output power density (right y) as a function of positive gate bias under b-particle illumination.

FIG. 11 shows at: (a) a schematic diagram of the Mo/n-4H—SiC epitaxial SBD structure; and at: (b) a photograph of an 8 mm×8 mm detector mounted on a printed circuit board (PCB) exposed to an UV LED.

FIG. 12 shows at: (a) a graph showing variation of current density with bias for a Mo/4H—SiC epitaxial SBD; and at (b) a graph of C-V characteristic (left y-axis) and the Mott-Schottky plot (A²/C² vs. V, A being the anode area, right y-axis.)

FIG. 13 shows at: (a) a graph of pulse height spectrum in self-biased mode obtained using the Mo/4H—SiC SBD exposed to a ²⁴¹Am radioisotope; and at: (b) a graph of variation of CCE and its various components as a function of the applied reverse bias.

FIG. 14 shows at: (a) a graph of I-V characteristics under dark and UV (365 nm) illumination of a Mo/4H—SiC SBD; and at: (b) a graph of forward current (left-y) and the output power (right-y) under UV illumination.

The figures herein are for illustrative purposes only and are not necessarily drawn to scale.

### DETAILED DESCRIPTION OF THE EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a”, “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g. given data set, art accepted standard, and/or with e.g. a given confidence interval (e.g. 90%, 95%, or more confidence interval from the mean), such as variations of +/−10% or less, +/−5% or less, +/−1% or less, and +/−0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

The term “molecular weight”, as used herein, can generally refer to the mass or average mass of a material. If a polymer or oligomer, the molecular weight can refer to the relative average chain length or relative chain mass of the bulk polymer. In practice, the molecular weight of polymers and oligomers can be estimated or characterized in various ways including gel permeation chromatography (GPC) or capillary viscometry. GPC molecular weights are reported as the weight-average molecular weight (M_{w}) as opposed to the number-average molecular weight (Mₙ). Capillary viscometry provides estimates of molecular weight as the inherent viscosity determined from a dilute polymer solution using a particular set of concentration, temperature, and solvent conditions.

As used interchangeably herein, the terms “sufficient” and “effective,” can refer to an amount (e.g., mass, volume, dosage, concentration, and/or time period) needed to achieve one or more desired and/or stated result(s). For example, a therapeutically effective amount refers to an amount needed to achieve one or more therapeutic effects.

As used herein, “tangible medium of expression” refers to a medium that is physically tangible or accessible and is not a mere abstract thought or an unrecorded spoken word. “Tangible medium of expression” includes, but is not limited to, words on a cellulosic or plastic material, or data stored in a suitable computer readable memory form. The data can be stored on a unit device, such as a flash memory or CD-ROM or on a server that can be accessed by a user via, e.g., a web interface.

As used herein, the terms “weight percent,” “wt %,” and “wt. %,” which can be used interchangeably, indicate the percent by weight of a given component based on the total weight of a composition of which it is a component, unless otherwise specified. That is, unless otherwise specified, all wt % values are based on the total weight of the composition. It should be understood that the sum of wt % values for all components in a disclosed composition or formulation are equal to 100. Alternatively, if the wt % value is based on the total weight of a subset of components in a composition, it should be understood that the sum of wt % values the specified components in the disclosed composition or formulation are equal to 100.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present disclosure. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure. For example, in the appended claims, any of the claimed embodiments can be used in any combination.

All patents, patent applications, published applications, and publications, databases, websites and other published materials cited herein are hereby incorporated by reference to the same extent as though each individual publication, published patent document, or patent application was specifically and individually indicated as being incorporated by reference.

### Kits

Any of the methods, systems, and high-performing metal-oxide-semiconductor (MOS) devices described herein can be presented as a combination kit. As used herein, the terms “combination kit” or “kit of parts” refers to the compounds, compositions, parts, and any additional components that are used to package, sell, market, deliver, and/or administer the combination of elements or a single element, such as a MOS device, contained therein. Such additional components include, but are not limited to packaging, blister packages, support materials and the like. When one or more of compounds, compositions, parts and any additional components described herein or a combination thereof (e.g., a MOS device provided alone, the combination kit can contain the device in a single combination or separate combinations. When the compounds, compositions, and parts and any additional components described herein or a combination thereof and/or kit components are not provided simultaneously, the combination kit can contain each component in separate combinations. The separate kit components can be contained in a single package or in separate packages within the kit.

In some embodiments, the combination kit also includes instructions printed on or otherwise contained in a tangible medium of expression. The instructions can provide information regarding the compounds, compositions, parts, and any additional components, safety information regarding the content of the compounds, compositions, parts, and any additional components, information regarding application of the methods, systems or MOS devices, and indications for use. In some embodiments, the instructions can provide directions and protocols for using the devices, compositions, parts, and any additional components described herein as well as directions for establishing/performing the systems/methods described in greater detail elsewhere herein.

Further embodiments are illustrated in the following Examples which are given for illustrative purposes only and are not intended to limit the scope of the disclosure.

The current disclosure provides novel, self-biased high-resolution radiation detectors based on an n-type 4H—SiC metal-oxide semiconductor (MOS) structure. Vertical MOS structure has been realized by pulsed laser deposition of 40 nm Y₂O₃ layer on 20 micron n-type 4H—SiC epilayer followed by sputter coating a nickel gate, which revealed a record-high hole diffusion length. The MOS device exhibited a remarkable radiation detection response to 5486 keV alpha particles with a charge collection efficiency of 82% and an energy resolution of 72 keV FWHM (1.5%) at zero applied bias. The hole diffusion length has been calculated to be 56 micron using a drift-diffusion model.

Such long hole diffusion length and a flat-band potential of 2.1 V, enabled to attain high efficiency and resolution in the self-biased mode. Band energy calculations indicated that the presence of Y₂O₃ layer may have neutralized the hole traps usually present in a metal-4H—SiC interface thereby substantially improving the hole transport. Such high performing self-biased radiation detectors fabricated on 4H—SiC are intended for applications in harsh environment space missions, wherein carrying detector power supplies as a payload becomes a critical logistic issue. The present disclosure opens the high potential of other wide bandgap semiconductors, e.g. GaN, Ga₂O₃, etc. as self-biased MOS devices as well.

4H—SiC radiation detectors are compact, low power consuming, and high performing devices in high temperature and high radiation environments, and hence, find applications as sensors and detectors in harsh environment applications. A self-biased 4H—SiC radiation detector is a much sought-after device for NASA's or DOD's space missions where carrying power supplies for biasing creates logistics issues. The discussed device concepts can also be applied for exploring other wide bandgap semiconductors, e.g., GaN, Ga₂O₃ etc.) as bias less operating radiation detectors.

The current disclosure provides novel device designs and new concepts which address challenges in field applications with high technological importance. The current disclosure will open new research avenues in homeland security, nuclear safeguard, non-proliferation, high-energy physics research, medical imaging, etc.

The current disclosure provides the fabrication of novel, self-biased high resolution radiation detectors achieved in n-type 4H—SiC metal-oxide-semiconductor (MOS) devices. Vertical MOS structure has been realized by pulsed laser deposition of 40 nm Y₂O₃ layer on 20 μm n-type 4H—SiC epilayer followed by sputter coating a nickel gate, which revealed a record-high hole diffusion length. The MOS device exhibited a remarkable radiation detection response to 5486 keV alpha particles with a charge collection efficiency of 82% and an energy resolution of 72 keV full width at half maximum (FWHM) at zero applied bias. The hole diffusion length has been calculated to be 56 μm using a drift-diffusion model.

This long hole diffusion length and a flat-band potential of 2.1 V, enabled high efficiency and resolution in the self-biased mode. Band energy calculations indicated that the presence of Y₂O₃ layer may have neutralized the hole traps usually present in a metal-4H—SiC interface thereby substantially improving the hole transport.

4H-silicon carbide has a unique combination of physical properties such as excellent carrier transport properties, high breakdown voltage, high displacement threshold, high thermal conductivity, chemical inertness and mechanical strength, that make it suitable as the only practical wide bandgap (3.27 eV) electronic material for harsh environment device and sensor fabrication. See, T. -H. Kil, M. Noguchi, H. Watanabe and K. Kita, “Impacts of Al₂O₃/SiO₂ interface dipole layer formation on the electrical characteristics of 4H—SiC MOSFET,” IEEE Electron. Device Lett., vol. 43, no. 1, pp. 92-95, January 2022, doi: 10.1109/LED.2021.3125945; S. K. Chaudhuri and K. C. Mandal, “Radiation Detection Using n-Type 4H—SiC Epitaxial Layer Surface Barrier Detectors,” in Iniewski K. (ed) Advanced Materials for Radiation Detection, Cham., Springer, August 2021, pp. 183-209. doi: 10.1007/978-3-030-76461-6_9; P. G. Neudeck, D. J. Spry, L. Chen, N. F. Prokop and M. J. Krasowski, “Demonstration of 4H—SiC digital integrated circuits above 800° C.,” IEEE Electron Dev. Lett., vol. 38, no. 8, pp. 1082-1085, August 2017, doi:10.1109/LED.2017.2719280; [4] F. H. Ruddy, L. Ottaviani, A. Lyoussi, C. Destouches, O. Palais and C. Reynard-Carette, “Performance and applications of silicon carbide neutron detectors in harsh nuclear environments.” EPJ Web Conf., vol. 253, p. 11003, November 2021, doi: 10.1051/epjconf/202125311003; F. Zhao, M. M. Islam, P. Muzykov, A. Bolotnikov and T. S. Sudarshan, “Optically activated 4H—SiC p-i-n diodes for high-power applications,” IEEE Electron Device Lett., vol. 30, no. 11, pp. 1182-1184, 2009, doi:10.1109/LED.2009.2031419; and M. Bora, L. F. Voss, P. V. Grivickas, D. L. Hall, J. B. Alameda, N. J. Kramer, A. M. Torres and A. M. Conway, “A total internal reflection photoconductive switch,” IEEE Trans. Electron Devices, vol. 40, no. 5, pp. 734-737, May 2019, doi: 10.1109/LED.2019.2903926.

Recent advancement in crystal growth technology has facilitated regular production of 250 μm thick single crystalline 4H—SiC epitaxial layers with ultralow point defect density 10¹¹ cm⁻³ and micropipe defect density <1 cm⁻². See, J. W. Kleppinger, S. K. Chaudhuri, O. Karadavut and K. C. Mandal, “Defect characterization and charge transport measurements in high-resolution Ni/n-4H SiC Schottky barrier radiation detectors fabricated on 250 μm epitaxial layers,” J. Appl. Phys., vol. 129, pp. 244501, June 2021, doi: 10.1063/5.0049218. Semiconductor single crystals with low defect density are crucial to electronic devices for achieving superior transport properties. See, S. O. Kasap, M. Z. Kabir, K. O. Ramaswami, R. E. Johanson and R. J. Curry, “Charge collection efficiency in the presence of non-uniform carrier drift mobilities and lifetimes in photoconductive detectors,” J. Appl. Phys., vol. 128, pp. 124501, June 2020, doi: 10.1063/5.0017521. Schottky barrier 4H—SiC devices have been well established as radiation detectors for harsh environment applications such as space missions, high energy astrophysics, nuclear reactor cores, and laser generated plasma environments. See, J. D. Wrbaneck and S. Y. Wrbaneck, “Space Radiation and Impact on Instrumentation Technologies,” Glenn Research Center, NASA/TP-2020-220002, 2020; G. Bertuccio, D. Puglisi, D. Macera, R. D. Liberto, M. Lamborizio and L. Mantovani, “Silicon carbide detectors for in vivo dosimetry,” IEEE Trans. Nucl. Sci., vol. 61, no. 2, pp. 961-966, April 2014, doi:10.1109/TNS.2014.2307957; C. S. Bodie, G. Lioliou and A. M. Barnett, “Hard X-ray and g-ray spectroscopy at high temperatures using a COTS SiC photodiode,” Nucl. Instrum. Meth. Phys. Res. A, vol. 985, pp. 164663, January 2021, doi:10.1016/j.nima.2020.164663; and G. Bertuccio, D. Puglisi, L. Torrisi and C. Lanzieri, “Silicon carbide detector for laser-generated plasma radiation,” Appl. Surf Sci., vol. 272, pp. 128-131, 2013, doi: 10.1016/j.apsusc.2012.03.183.

Incorporating an insulating layer with high dielectric constant (k) at the metal/semiconductor interface results in band offset which can be utilized to modulate the barrier height, an important device parameter to control the device leakage current. See, S. Y. Chiam, W. K. Chim, C. Pi, A. C. Huan, S. J. Wang, J. S. Pan, S. Turner and J. Zhang, “Band alignment of yttrium oxide on various relaxed and strained semiconductor substrates,” J. Appl. Phys., vol. 103, pp. 083702, April 2008, doi: 10.1063/1.2904928.; M. B. Clavel, M. K. Hudait, “Band offset enhancement of a-Al₂O₃/Tensile-Ge for high mobility nanoscale pMOS devices,” IEEE Electron Device Lett., vol. 38, no. 9, pp. 1196-1199, July 2017, doi:10.1109/LED.2017.2734040; and G. Choi, H. H. Yoon, S. Jung, Y. Jeon, J. Y. Lee, W. Bahng and K. Park, “Schottky barrier modulation of metal/4H—SiC junction with thin interface spacer driven by surface polarization charge on 4H—SiC substrate,” Appl. Phys. Lett., vol. 107, pp. 252101, December 2015, doi: 10.1063/1.4938070.

High-k interfacial layers are also known to improve the barrier properties through surface passivation. Investigations on several high-k dielectric oxide layers such as Al₂O₃, CeO₂, La₂O₃, HfO₂, TiO₂, and Y₂O₃ deposited on 4H—SiC has been reported. See, doi: 10.1109/LED.2021.3125945; A. Siddiqui, R. Y. Khosa and M. Usman, “High-k dielectrics for 4H-silicon carbide: present status and future perspectives,” J. Mater. Chem. C, vol. 9, no. 15, pp. 5055-5081, March 2021, doi: 10.1039/D0TC05008C; and F. Zhao, O. Amnuayphol, K. Y. Cheong, Y. W. Wong, J. -Y. Jiang and C. -F. Huang, “Post deposition annealing effect on properties of Y₂O₃/Al₂O₃ stacking gate dielectric on 4H—SiC,” Mat. Lett., vol. 245, pp. 174-177, March 2019, doi: 10.1016/j.matlet.2019.03.009. Yttrium oxide (Y₂O₃) among such dielectrics provides wide bandgap (5.5 eV) as well as high k=15-18. See, H. J. Quah, W. F. Lim, S. C. Wimbush, Z. Lockman and K. Y. Cheong, “Electrical properties of pulsed laser deposited Y₂O₃ gate oxide on 4H—SiC,” Electrochem. Solid-State Lett., vol. 13, no. 11, pp. H396-H398, September 2010, doi: 10.1149/1.3481926. Wide bandgap of the interfacial oxide layer helps to reduce leakage current by increasing the junction barrier height. The combination of high dielectric constant and wide bandgap makes Y₂O₃/4H—SiC stack a unique structure for radiation detection. Y₂O₃ has been investigated as a high k dielectric and is reported to exhibit low charge density, low leakage current, and very high dielectric strength for 4H—SiC MOSFETs as well. See, doi: 10.1016/j.matlet.2019.03.009. Nevertheless, reports on metal/Y₂O₃/4H—SiC MOS structure as radiation detectors are meagre.

This disclosure provides the radiation detection response of Ni/Y₂O₃/n-4H—SiC vertical MOS devices at 0 V applied bias (self-biased). The Y₂O₃ layers has been deposited using pulsed laser deposition (PLD) which offers high degree of stoichiometry, high deposition rates and precise control over the film thickness. The role of minority carrier diffusion length in obtaining high-resolution self-biased detectors has also been investigated. Such detectors are critical to applications such as space missions where simplistic, zero-maintenance, compact, and light-weight form-factors are prioritized.

### Experimental Methods

Square shaped wafers with 8 mm edge length were diced from a chemical vapor deposition (CVD) grown 20 μm thick n-type 4H—SiC epitaxial layers on the (0001) Si face of a highly conducting (≈0.02 Ω-cm) n-type 4H—SiC substrate 4° off-cut towards the [112̅0̅] direction. An unintentional nitrogen doping concentration of (1-3)×10¹⁴ cm⁻³ were measured in the epilayers. The diced wafers were cleaned using a standard RCA procedure following which the native oxide layer was etched off using a HF solution. See, W. Kern, “The evolution of silicon wafer cleaning technology,” J. Electrochem. Soc., vol. 137, no. 6, pp. 1887-1892, June 1990, doi: 10.1149/1.2086825.

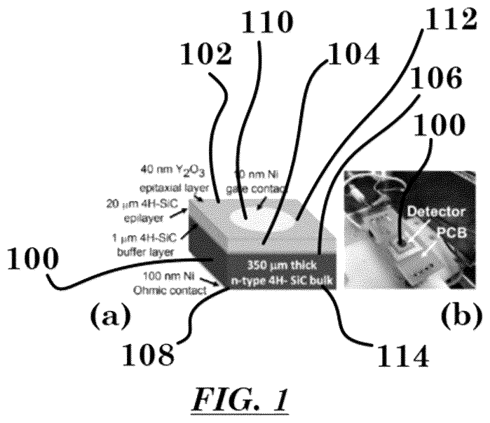

Y₂O₃ layer 102 of thickness ≈40 nm was epitaxially grown on a 4H—SiC epilayer 104 using PLD. A KrF excimer laser emitting at 248 nm with a pulse rate of 5 Hz was used with a fluence of 2 J/cm². The depositions were carried out under an oxygen partial pressure of 50 mTorr at 700° C. A circular shaped (ø=2.9 mm) thin (10 nm) nickel contact 110 was sputter coated on the Y₂O₃ layer 102 to form gate 112. A square (6 mm×6 mm) 100 nm thick nickel contact 108 was deposited on the bulk side of the 4H—SiC wafer 106 as back Ohmic contact 114. The schematic of the MOS detector 100 and a photograph of detector 100 used in this study is shown in FIG. 1. FIG. 1 shows at: (a) a schematic diagram of the Ni/Y₂O₃/4H—SiC epitaxial MOS detector and at: (b) a photograph of an 8 mm×8 mm detector mounted on a PCB for radiation spectroscopy measurements.

The current-voltage characteristics have been acquired at room-temperature using a Keithley 237 source-measure unit. The pulse height measurements were carried out using a benchtop spectrometer, a Cremat CR110 preamplifier and a 0.9 μCi²⁴¹ Am radioisotope.

### Results And Discussion

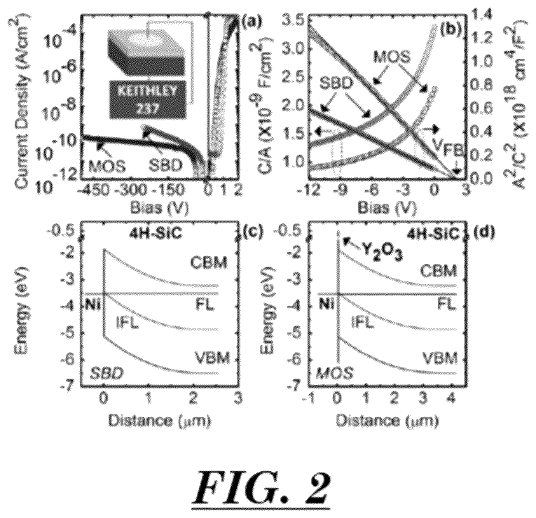

FIG. 2 at: (a) shows the variation of leakage current density (J) measured at room temperature as a function of the applied bias (Vₐ) for a Ni/Y₂O₃/4H—SiC epitaxial MOS detector. The J-V characteristics of a Schottky barrier detector (SBD) fabricated on a similar 20 μm 4H—SiC epitaxial layer (except for the Y₂O₃ layer) has also been plotted in FIG. 2 at (a) for comparison. The SBD is one of the highest resolution detectors reported previously by our research group. See, S. K. Chaudhuri, K. J. Zavalla and K. C. Mandal, “High resolution alpha particle detection using 4H—SiC epitaxial layers: Fabrication, characterization, and noise analysis,” Nucl. Instrum. Method Phys. Res. A, vol. 728, pp. 97-101, November 2013, doi: 10.1016/j.nima.2013.06.076. Both the devices showed strong rectification with respect to bias polarity. For convenience, the terms forward and reverse would be used henceforth to specify the positive and reverse gate/anode bias polarities, respectively. The MOS detector exhibited a reverse leakage current density of 6×10⁻¹¹ A/cm² at a reverse bias of −250 V, one order of magnitude lower than that observed in the SBD at the same bias, which did not change much up to −500 V. The semi-log J-V plot for the SBD in forward bias showed a linear trend commensurate with thermionic emission. See, S. M. Sze and K. K. Ng, Physics of Semiconductor Devices, New Jersey: John Wiley & Sons, 2007. The same for the MOS detector is seen to be nonlinear indicating a deviation from the thermionic emission model, possibly due to the presence of the Y₂O₃ layer.

FIG. 2 at: (b) shows the variation of the specific capacitance for the MOS and the SBD with bias, and the corresponding Mott-Schottky plots. A built-in potential of 2.1 V has been calculated for both the devices from the linear fit of the Mott-Schottky plots. Although both the detectors have been fabricated on epilayers grown under similar conditions, the concentration of the unintentional nitrogen dopants varied resulting in the observed difference of the device capacitance. The effective doping concentrations of the SBD and the MOS detector were calculated to be 3.4×10¹⁴ and 1.3×10¹⁴ cm⁻³, respectively from the Mott-Schottky plots.

FIG. 2 at: (c) and (d) show the band diagram calculated for the SBD and MOS structures using a modular 1-D Poisson equation solver. See, R. G. Southwick III, A. Sup, A. Jain and W. B. Knowlton, “An interactive simulation tool for complex multilayer dielectric devices,” IEEE Trans. Device. Mater. Reliab., vol. 11, no. 2, pp. 236-243, June 2011, doi:10.1109/TDMR.2011.2129593. The deviation of the zero bias capacitance calculated using the band diagram from the experimentally measured value were found to be 26% and 13% for the SBD and the MOS detector, respectively. No interfacial charge or oxide layer fixed charge has been considered for the above calculations. Considering that the higher deviation for the SBD may have caused due to presence of surface states in the real device, the better match of the calculated and experimental junction capacitance in the MOS device indicates the role of the Y₂O₃ layer in subduing the effect of the interfacial charge states. FIG. 2 shows at: (a) variation of current density with bias for a Ni/Y₂O₃/n-4H—SiC epitaxial MOS detector and a Ni/n-4H—SiC epitaxial SBD; (b) variation of specific capacitance with reverse bias. The right y-axis has been used for the Mott-Schottky plots. The solid lines show the linear fits. (c)-(d) show the band diagrams calculated for the SBD and MOS interfaces, respectively. CBM, VBM, IFL, FL refers to conduction band minimum, valence band maximum, intrinsic Fermi level, and the bulk Fermi level.

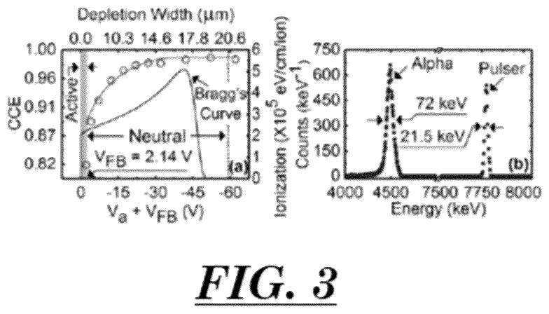

At zero applied bias, the flat-band potential generates an electric field in a direction that would facilitate minority carriers (holes) to drift across the depletion width. Being an n-type wide bandgap semiconductor there are negligible number of holes in 4H—SiC at equilibrium that take part in conduction. However, once the detectors are exposed to ionizing radiation, a large number of electron-hole pairs (ehps) are generated. Considering an ehp creation energy of 7.28 eV, see S. K. Chaudhuri, K. J. Zavalla and K. C. Mandal, “Experimental determination of electron-hole pair creation energy in 4H—SiC epitaxial layer: An absolute calibration approach,” Appl. Phys. Lett., vol. 102, pp. 031109, January 2013, doi: 10.1063/1.4776703, a 5486 keV alpha particle would create ≈700,000 ehps in a single interaction. In the case that the alpha particles are stopped within the depletion width, or the active region, both the electrons and holes drift toward the electrodes biased at favorable potential. At zero bias however, the depletion region is very narrow and most of the alpha particles end up generating a substantial fraction of the ehps in the epilayer beyond the depletion width or the neutral region. The Bragg' s curve in FIG. 3 at (a) calculated using SRIM, see J. F. Ziegler, M. D. Ziegler and J. P. Biersack, “SRIM—The stopping and range of ions in matter (2010),” Nucl. Instrum. Meth. Phys. Res. B, vol. 268, no. 11-12, pp. 1818-1823, June 2010, doi:10.1016/j.nimb.2010.02.091, which plots the number of ions created per unit energy and per unit penetration depth, shows that majority of the charge pairs are generated at a depth of ≈17 μm, while the depletion width at the 0 V (V_{FB}=2.14 V) applied bias is only 3.82 μm. Under such condition, some of the holes generated in the neutral region diffuse towards the active region and reaches the edge of depletion width. The holes reaching the depletion edge then drift under the action of the flat-band potential and are collected by the anode/gate. The fraction of holes that reach the edge of the active region through diffusion in the neutral region depends on the minority carrier diffusion length L_{d}. Hence, the charge collection efficiency of the detector in self-biased mode, depends on the flat-band voltage, as well as the minority carrier diffusion length. It may be noted that the hole transport in 4H—SiC is relatively poor compared to the electron transport, and hence the resulting charge collection are usually very different. The hole mobility-lifetime product in 4H—SiC has been reported to be 8×10⁻⁵ compared to 4×10⁻⁴ cm²/V for electrons. See, A. Owens and A. Peacock, “Compound semiconductor radiation detectors,” Nucl. Instrum. Meth. Phys. Res. A, vol. 531, no. 2004, pp. 18-37, June 2004, doi: 10.1016/j.nima.2004.05.071. Hence, the energy resolution under pure hole transport will never be as high as measured for pure electron transport. FIG. 3 shows at: (a) variation of CCE with bias voltage. The error bars in the calculated CCEs are smaller than the data point symbol. The solid line shows the least square fitting according to a drift-diffusion model. The Bragg curve has been plotted on the right-y and top-x axis. At (b), a pulse height spectrum obtained by exposing the MOS detector to 5486 keV α-particles. A pulser peak depicting the electronic noise is also shown.

To calculate the L_{d}, a drift-diffusion model has been applied to the variation of the charge collection efficiency (CCE or η) as a function of the bias voltage. See, M. B. H. Breese, “A theory of ion beam induced charge collection,” J. Appl. Phys., vol. 74, no. 6, pp. 3789-3799, June 1993, doi:10.1063/1.354471; J. W. Kleppinger, S. K. Chaudhuri, O. F. Karadavut, R. Nag and K. C. Mandal, “Influence of carrier trapping on radiation detection properties in CVD grown 4H—SiC epitaxial layers with varying thickness up to 250 μm,” J. Cryst. Growth, vol. 583, pp. 126532, January 2022, doi:10.1016/j.jcrysgro.2022.126532; and X. Geng, X. Xia, J. Liu, X. Cui, Sun, H. Huang, D. Xue, X. Liang, X. Meng and H. Liang, “Charge transport mechanism of self-powered GaN p-i-n α-particle detector,” Superlattices Microstruct., vol. 143, pp. 106563, July 2020, doi: 10.1016/j.spmi.2020.106563. The CCE has been defined as the ratio of the charge collected at an electrode to the charge induced in the detector. As the induced charge is proportional to the incident energy (E_{α}=5486 keV), and the collected charge is proportional to the corresponding peak position (Eₚ) in the pulse height spectrum expressed in keV, the CCE has been calculated as η=Ep/5486. FIG. 3 at: (a) also shows the variation of the CCE as a function of the net bias. The drift-diffusion model relates the total CCE to the fraction of charges generated in the active and the neutral regions as given below.

$$η = \frac{1}{{E}_{a}} {\int }_{0}^{{x}_{d}} ( \frac{dE}{dx} ) dx + {\int }_{{x}_{d}}^{{x}_{r}} ( \frac{dE}{dx} ) exp [ - \frac{x - {x}_{d}}{{L}_{d}} ] dx . \qquad ( 1 )$$

Here, dE/dx is the stopping power of the incident alpha particles in 4H—SiC, x_{d} is the depletion width at the bias for which η is being calculated, xᵣ is the range of the alpha particles and x is the distance within the 4H—SiC epilayer measured from the Y₂O₃ interface. Equation 1 is fitted to the η vs (Vₐ+VFB) plot in FIG. 3 at (a) with L_{d} as a free parameter. The best fit yielded L_{d}=56 μm, which is almost three times of that obtained in highest resolution SBDs, see doi: 10.1016/j.nima.2013.06.076, S. K. Chaudhuri, O. Karadavut, J. W. Kleppinger and K. C. Mandal, “High-resolution radiation detection using Ni/SiO₂/n-4H—SiC vertical metal-oxide-semiconductor capacitor,” J. Appl. Phys., vol. 130, pp. 074501, July 2021, doi: 10.1063/5.0059151, and O. Karadavut, S. K. Chaudhuri, J. W. Kleppinger, R. Nag and K. C. Mandal, “Effect of oxide layer growth conditions on radiation detection performance of Ni/SiO₂/epi-4H—SiC MOS capacitors,” J. Cryst. Growth, vol. 584, pp. 126566, February 2022, doi: 10.1016/j.jcrysgro.2022.126566. The CCE obtained at Vₐ=0 V was found to be 82% which is also very high compared to the 57% obtained for the high-resolution SBDs fabricated in our laboratory and others, see doi: 10.1016/j.nima.2013.06.076, A. M. Ivanov, E. V. Kalinina, A. O. Konstantinov, G. A. Onushkin, N. B. Strokan, G. F. Kholuyanov and A. Hallén, “High-resolution short range ion detectors based on 4H—SiC films,” Tech. Phys. Lett., vol. 30, no. 7, pp. 575-577, July 2004, doi: 10.1134/1.1783406, and K. C. Mandal, J. W. Kleppinger and S. K. Chaudhuri, “Advances in high-resolution radiation detection using 4H—SiC epitaxial layer devices,” Micromachines, vol. 11, no. 3, pp. 254, February 2020, doi:10.3390/mi11030254. Neutron detectors with converting thin film layers (which acts as the source) directly deposited on the detector itself has only demonstrated such high CCE at zero bias. See, J. H. Ha, S. M. Kang, S. H. Park, H. S. Kim, N. H. Lee and T. -Y. Song, “A self-biased neutron detector based on an SiC semiconductor for a harsh environment,” Appl. Radiat. Isot., vol. 67, no. 7-8, pp. 1204-1207, July-August, 2009, doi: 10.1016/j.apradiso.2009.02.013. FIG. 3 at: (b) shows the pulse height spectrum obtained using the Ni/Y₂O₃/4H—SiC MOS detector when exposed to the 5486 keV alpha particles. The full width at half maximum (FWHM) of the alpha peak was calculated to be 72 keV, an excellent energy resolution for a self-biased radiation detector, which can be efficiently used for high-resolution radiation spectroscopy measurements.

The possibility of stacked Ni/Y₂O₃/4H—SiC epitaxial MOS device structure as a self-biased radiation detector for space-applications has been investigated. These robust, compact, and low power devices are ideal not only for radiation spectroscopy in harsh environment applications but also for MOSFETs with high breakdown voltage. Barrier characterization and radiation detection measurements confirmed that epitaxial Y₂O₃ layer can enhance the barrier properties through surface passivation to obtain very high-resolution and high efficiency self-biased radiation detectors with ultra-low leakage currents. The detectors have demonstrated extremely long hole diffusion length which resulted in the enhanced self-biased performance. Although evidence indicate that the observed large hole diffusion length resulted due to the presence of the Y₂O₃ layer, further investigations are required to reveal the exact mechanism behind such an enhancement. The effect of the Y₂O₃ growth conditions, such as deposition rate, temperature, pressure, and thickness will also be explored in the future studies to optimize the radiation detection performance.

Further, the current disclosure provides a novel vertical heteroepitaxial metal-oxide-semiconductor (MOS) device with extremely high minority carrier diffusion length has been characterized as a betavoltaic cell for power generation in harsh environment applications where solar photovoltaics cannot operate. The MOS structure has been realized by epitaxial growth of 40 nm thick yttrium oxide (Y2O3) layer through pulsed laser deposition on 20 μm thick n-type 4H—SiC epilayers with ultralow defect concentration.

A 10 nm thick circular (10 mm²) nickel contact was deposited as the gate contact. The surface passivation effect of the Y2O3 layer and its large bandgap resulted in an extremely low leakage current density of 57 pA/cm² at a reverse bias of −250 V, which is an order of magnitude less than that observed in benchmark Schottky barrier detectors at the same bias. The thin Y2O3 layer showed minimal absorption of 5486-keV alpha particles when exposed to a ²⁴¹Am source and demonstrated a charge collection efficiency of 82%, measured in self-biased mode (0 V applied bias). When exposed to a 5 mCi ⁶³Ni beta source, the MOS devices demonstrated an output power density of 11 nW/cm³ and a fill factor >66% even with a partial illumination. The single pixel MOS devices discussed herein shows a very high prospect to reach the maximum theoretical conversion efficiency of 25% predicted by the Klein relationship.

There are many applications where power supplies attached to electronic devices need to be qualified as zero-maintenance for prolonged period of operation. Such applications include, but are not limited to, space missions, deep ocean or volcanic missions, cardiac pacemakers, expression and properties of proteins in biological systems, and automated scientific stations in remote parts of the world. See, S. I. Maximenko, J. E. Moore, C. A. Affouda, P. P. Jenkins, Optimal semiconductors for ³H and ⁶³Ni betavoltaics. Sci. Rep. 9, 10892 (2019). doi.org/10.1038/s41598-019-4 7371-6 and J. Dixon, A. Rajan, S. Bohlemann, D. Coso, A. D. Upadhyaya, A. Rohatagi, S. Chu, A. Majumdar, S. Yee, Evaluation of a silicon ⁹⁰Sr betavoltaic power source. Sci. Rep. 6, 38182 (2016). doi.org/10.1038/srep38182.

Although stand-alone compact power supplies such as lithium cells/batteries or solar photovoltaic cells are used to power many present-day electronic devices, they are not suitable for harsh environment applications such as those involving extreme temperatures and high radiation background. Also, lithium batteries discharge rapidly, need regular recharging, and the capacity of lithium-ion batteries reduces to 70-90% within few years of usage. See, M. Li, J. Yang, Y. Shi, Z. Chen, P. Bai, H. Su, P. Xiong, M. Cheng, J. Zhao, Y. Xu, Soluble organic cathodes enable long cycle life, high rate, and wide-temperature lithium-ion batteries. Adv. Mater. 34(5), 2107226 (2021). doi.org/10.1002/adma.202107226. Moreover, there are many terrestrial and extra-terrestrial applications such as deep ocean and distant planetary missions where solar photovoltaic batteries do not work due to the absence of adequate sunlight.

Nuclear radiovoltaic batteries are ideal for powering electronic devices in operations that last for decades. With the availability of high-quality semiconductor converters and bio-friendly radiation sources, there has been a tremendous escalation of research interest recently in radiovoltaics. See, S. K. Chaudhuri, O. Karadavut, J. W. Kleppinger, R. Nag, G. Yang, D. Lee, K .C. Mandal, Enhanced hole transport in Ni/Y₂O₃/n-4H—SiC MOS for self-biased radiation detection. IEEE Electron Device Lett. 43(9), 1416-1419 (2022). doi.org/10.1109/LED.2022.3188543, J. W. Kleppinger, S. K. Chaudhuri, O. Karadavut, K. C. Mandal, Defect characterization and charge transport measurements in high-resolution Ni/n-4H SiC Schottky barrier radiation detectors fabricated on 250 lm epitaxial layers. J. Appl. Phys. 129, 244501 (2021). doi.org/10.1063/5.0049218, G. Lioliou, A. M. Barnett, Electron-hole pair creation and conversion efficiency in radioisotope microbatteries. Appl. Rad. Isotopes 180, 110042 (2021). doi.org/10.1016/j.apradiso.2021.110042, A. O'Connor, M. V. Manuel, S. Harry, An extended-temperature, volumetric source model for betavoltaic power generation. Trans. Am. Nucl. Soc. 121, 542-545 (2019), and M. G. Spencer, T. Alam, High power direct energy conversion by nuclear batteries. Appl. Phys. Rev. 6, 031305 (2019). doi.org/10.1063/1.5123163, G. Lioliou, A. B. Krysa, A. M. Barnett, Wide bandgap semiconductor conversion devices for radioisotope microbatteries. Mater. Sci. Semicond. Proc. 142, 106533 (2022). doi.org/10.1016/j.mssp.2022.106533, T. Shimaoka, H. Umezawa, K. Ichikawa, J. Pernot, S. Koizumi, Ultrahigh conversion efficiency of betavoltaic cell using diamond pn junction. Appl. Phys. Lett. 117, 103902 (2020). doi.org/10.1063/5.0020135, and J. W. Murphy, L. F. Voss, C. D. Frye, Q. Shao, K. Kazkaz, M. A. Stoyer, R. A. Henderson, R. J. Nikolic, Design considerations for three-dimensional betavoltaics. AIP Adv. 9, 065208 (2019). doi.org/10.1063/1.5097775.

Radiovoltaic is a class of non-thermal direct-conversion nuclear batteries, which works on a concept similar to that of photovoltaic solar cells, except for the fact that creation of charge pairs in the converter material is induced by nuclear radiations such as alpha particles, beta particles, or gamma rays, instead of visible electromagnetic radiation. The radioisotopes that emit the ionizing radiation can last for decades, if not more, as they have substantially long half-lives. For instance, the half-life of beta particle emitting ⁶³Ni radioisotope is ˜99 years.

Wide bandgap semiconductors have been demonstrated as effective converter materials with very high conversion efficiency. Conversion efficiency is defined as the ratio of the maximum power output to the incident power received by the converter from the radioactive source. The maximum conversion efficiency of cubic phase boron nitride (c-BN) with a bandgap of ≈6.2 eV has been predicted to be around 30% compared to the 10% obtainable in silicon (1.12 eV)-based betavoltaic cells. See, G. Lioliou supra. Being a wide bandgap (3.27 eV), radiation hard, high-temperature compatible, and solar blind semiconductor and due to its commercial availability as electronic grade material, 4H—SiC epilayer has been a popular choice for the converter material in radiovoltaics since a long time. See Id. 4H—SiC readily forms Schottky junctions with most metals and shows excellent rectification properties. See, K. C. Mandal, J. W. Kleppinger, S. K. Chaudhuri, Advances in high-resolution radiation detection using 4H—SiC epitaxial layer devices. Micromachines 11(3), 254 (2020). doi.org/10.3390/mi11030254. Even so, the conversion efficiency of the best 4H—SiC-based betavoltaic cell has been reported to be 10-12% for ⁶³Ni beta-emitter, which is below half of that predicted theoretically (≈25%) using Klein's relationship. See, C. A. Klein, Bandgap dependence and related features of radiation ionization energies in semiconductors. J. Appl. Phys. 39, 2029-2038 (1968). doi.org/10.1063/1.1656484. The main impediments in achieving the maximum efficiency are poor radiocurrent due to excessive charge trapping in defects, high surface recombination, and higher leakage current in the commercially available 4H—SiC epilayers.

Recent development of high-quality 4H—SiC epilayers with ultralow microscopic and macroscopic defect concentration, high degree of crystallinity, and excellent charge transport properties have shown high prospects in achieving the optimum conversion efficiency of 4H—SiC betavoltaic cells. See, J. W. Kleppinger supra and S. K. Chaudhuri, K. C. Mandal, Radiation detection using n-type 4H—SiC epitaxial layer surface barrier detectors, in Advanced Materials for Radiation Detection. ed. by K. Iniewski (Springer, Berlin, 2021), pp.183-209. Lower defect density in semiconductor single crystals is crucial to achieving superior transport properties. See, S. O. Kasap, M. Z. Kabir, K. O. Ramaswami, R. E. Johanson, R. J. Curry, Charge collection efficiency in the presence of non-uniform carrier drift mobilities and lifetimes in photoconductive detectors. J. Appl. Phys. 128, 124501 (2020). doi.org/10.1063/5.0017521 and K. Ramaswami, R. Johanson, S. Kasap, Charge collection efficiency in photoconductive detectors under small to large signals. J. Appl. Phys. 125, 244503 (2019). doi.org/10.1063/1.5096900. In our previous work, we have demonstrated extremely long hole diffusion length of 56 μm and high flat-band potential of 2.1 V in Ni/Y2O3/4H—SiC vertical metal-oxide-semiconductor (MOS) devices that led to very high charge collection efficiency and energy resolution in self-biased (0 V applied bias) mode. See, S. K. Chaudhuri supra. Like 4H—SiC, Y2O3 is a wide bandgap (5.4 eV) radiation hard semiconductor that is suitable for high-temperature operation. Being a high-k dielectric (k=15-18 is the dielectric constant), Y2O3 helps to reduce the leakage current through the junction substantially. See, H. J. Quah, W. F. Lim, S. C. Wimbush, Z. Lockman, K. Y. Cheong, Electrical properties of pulsed laser deposited Y₂O₃ gate oxide on 4H—SiC. Electrochem. Solid-State Lett. 13(11), H396-H398 (2010). doi.org/10.1149/1.3481926. The Y2O3 layer also passivates the 4H—SiC epilayer surface and hence reduces the surface recombination velocity. The high quality wide bandgap 4H—SiC converter material and superior self-biased operability of the Ni/Y2O3/4H—SiC MOS devices can be leveraged to obtain highly efficient radiovoltaic cells.

In the present work, we investigated the betavoltaic properties of Ni/Y2O3/4H—SiC heteroepitaxial MOS devices to design next generation compact micro-batteries for harsh environment applications with conversion efficiency close to the theoretically predicted value.

### Experimental Details

### MOS Device Fabrication

Highly crystalline 20 μm thick n-type 4H—SiC epilayers, grown using hot-walled chemical vapor deposition (CVD), have been used for device fabrication. The epilayers have been grown on the offcut (0001) plane (Si-face) of 10 cm-diameter 350 μm thick highly doped (electrical resistance ranging between 0.015 and 0.028 Ω-cm) n-type substrates. The offcut (0001) plane is inclined by 4° toward the <1120> direction. In the case of homoepitaxial growth of 4H—SiC, an offcut facilitates the uniformity of 4H—SiC polytype by hindering the growth of thermodynamically favored cubic 3C—SiC polytype. See, H. Matsunami, T. Kimoto, Step-controlled epitaxial growth of SiC: high quality homoepitaxy. Mater. Sci. Eng. R Rep. 20(3), 125-166 (1997). doi.org/10.1016/S0927-796X(97)00005-3. However, higher offcut angle leads to the replication of basal plane dislocation (BPD) and material wastage. The 4° offcut angle in the present growth, lower than the 8° offcut used in our state-of-the-art 4H—SiC epitaxial layer detectors, makes the conversion of BPD to threading edge dislocation (TED) more favorable resulting in higher crystallinity and lower material wastage. The conversion of BPDs to TEDs is preferred as TEDs are more benign compared to BPDs in terms of charge trapping and recombination. See, J. J. Sumakeris, J. R. Jenny, A. R. Powell, Bulk crystal growth, epitaxy, and defect reduction in silicon carbide materials for microwave and power devices. MRS Bull. 30(4), 280-286 (2011). doi.org/10.1557/mrs2005.74. A 1 μm thick buffer layer was also grown on the substrate to suppress the propagation of defects viz. dislocations, particles, stains, etc., from the substrate to the epilayer. See, N. Piluso, A. Severino, R. Anzalone, M. A. Di Stefano, E. Fontana, M. Salanitri, S. Lorenti, A. Campione, P. Fiorenza, F. La Via, Growth of 4H—SiC epitaxial layer through optimization of buffer layer. Mater. Sci. Forum. 924, 84-87 (2018). doi.org/10.4028/www.scientific.net/MSF.924.84.

The oxide layer deposition has been carried out using pulsed laser deposition (PLD). PLD enables a high degree of stoichiometry, fast deposition rates, and precise control over the film thickness. The PLD system used in this work comprises an NBM Design Inc., deposition chamber and a Coherent Inc., COMPex excimer laser emitting at λ=248 nm with a pulse rate of 5 Hz and laser fluence of 2 J/cm². The laser was used to irradiate the Y2O3 disk target. An oxygen partial pressure of 100 mTorr was maintained in the chamber and the specimen temperature was recorded to be 700 C during the growth. Square specimens measuring 8 mm×8 mm in dimensions were diced from the polished parent 4H—SiC epilayer wafers and cleaned using a Radio Corporation of America (RCA) cleaning protocol. See, W. Kern, The evolution of silicon wafer cleaning technology. J. Electrochem. Soc. 137(6), 1887-1892 (1990). doi.org/10.1149/1.2086825. The cleaned wafers were dipped in 10% dilute HF acid for 1 min to etch the native SiO2 layer off the 4H—SiC epilayer and were stored in a desiccator to prevent further oxide formation before loading them into the PLD chamber. The 4H—SiC specimens were mounted on glass substrates using silver epoxy and placed inside the PLD chamber. Y2O3 film thickness of 40 nm was achieved in 15 min. The thickness of the films was measured through X-ray reflectometry using a Rigaku X-ray diffractometer.

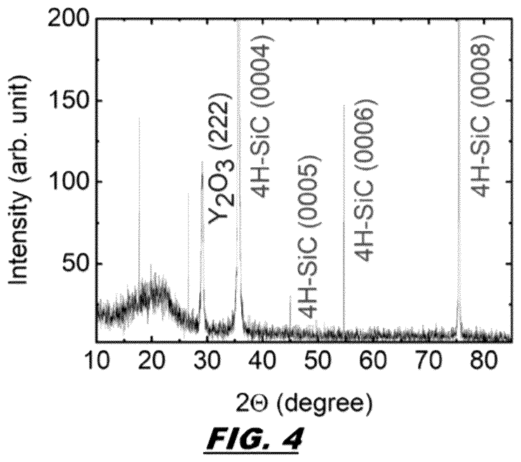

FIG. 4 shows the wide-angle X-ray diffractogram of the Y2O3/4H—SiC heteroepitaxial structure recorded using Cu K_{α} rays. A single XRD peak corresponding to the (222) Y2O3 plane was observed among the standard 4H—SiC peaks, which confirms the epitaxial growth of the Y2O3 layers. See, I. C. Robin, R. Kumaran, S. Penson, S. E. Webster, T. Tiedje, A. Oleinik, Structure and photoluminescence of Nd:Y2O3 grown by molecular beam epitaxy. Opt. Mater. 30(6), 835-838 (2008). doi.org/10.1016/j.optmat.2007.03.003. Circular (Φ=4 cm) 10-nm thick Ni gate contact was deposited on the Y2O3 layer using a Quorum 150 T sputter coating unit to form the vertical MOS structure. A 100 nm thick Ni contact was deposited on the bulk side of the 4H—SiC epilayer to form an Ohmic back contact. Ni is a primary choice as contact metal to form both Schottky and Ohmic contacts in 4H—SiC. While Ni forms excellent Schottky barriers on the Si-face of 4H—SiC, it forms Ohmic contact with low contact resistance on the highly conducting C-face of 4H—SiC. Also, Ni has excellent adherence to the 4H—SiC surface and is highly stable against thermal stress.

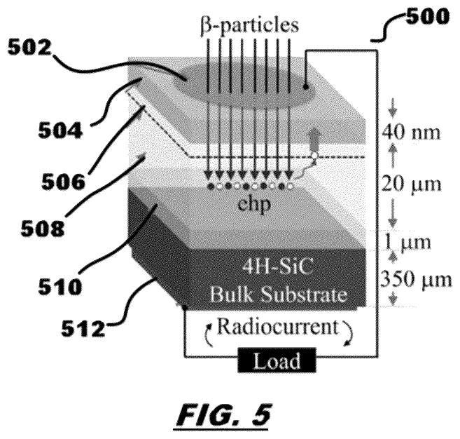

The schematic of the device structure is shown in FIG. 5. MOS device 500 may include a Ni Gate 502, a Y2O3 epilayer 504 below the Ni Gate 502, a depletion edge 506, a 4H—Si Epilayer 508, a 4H—SiC buffer layer 510, and a Ni Ohmic back contact 512. The MOS structure was mounted on a printed circuit board (PCB) in a way that the Ni back contact is in contact with a copper pad. A gold-coated spring contact arm touched the circular Ni gate contact and secured the device in place. The PCB contained header pins connected to the gate and the bulk side through copper traces on the PCB which were used to plug the MOS-PCB assembly to a receptacle motherboard inside a test box. The receptacle is internally wired to the BNC outlets on the test box. FIG. 4 shows An X-ray diffractogram obtained from a pulsed laser deposited 40 nm thick Y₂O₃ epilayer on a 20-μm thick n-type 4H—SiC epilayer. Only one peak related to the Y₂O₃ epilayer (diffraction from the (222)-plane) was visible in the range 10°≤2θ≤90°. FIG. 5 shows a schematic (not according to scale) of the Ni/Y₂O₃/4H—SiC MOS device configured as a betavoltaic cell. The electron-hole pairs (ehp) are shown as black (electron) and white (hole) circles. The squiggly arrow in the 4H—SiC epilayer shows a hole diffusing through the neutral region and approaching the depletion layer edge, and the block arrow shows the subsequent drift under the influence of the flat-band potential.

### Device Characterization

Current density-voltage (J-V) characteristic measurements were carried out using a Keithley 237 source-measure unit to investigate the electrical properties of the junction and the device. The capacitance-voltage (C-V) characteristics were measured using a capacitance meter with a test frequency of 1 MHz.

The minority carrier (hole) diffusion length was determined through pulse height spectroscopy with the devices configured as radiation detectors. The detectors were connected to an Amptek A250CF preamplifier, which generates a voltage signal whose magnitude is proportional to the charge created in the detector by the incident radiation. The preamplifier output was fed to an Ortec 576 spectroscopy amplifier to filter out the electronic noise. The output of the spectroscopy amplifier with a high signal-to-noise ratio was fed to a Canberra Multiport II multichannel analyzer, which generated the pulse height spectrum (PHS). The detectors were illuminated using a 0.9 μCi²⁴¹ Am radioisotope emitting primarily 5486-keV alpha particles to record the PHS. The source-detector assembly was placed inside a test box to shield off any electromagnetic interference. The test box was continually evacuated during the measurements to minimize any energy loss of the alpha particles due to scattering with the air molecules.

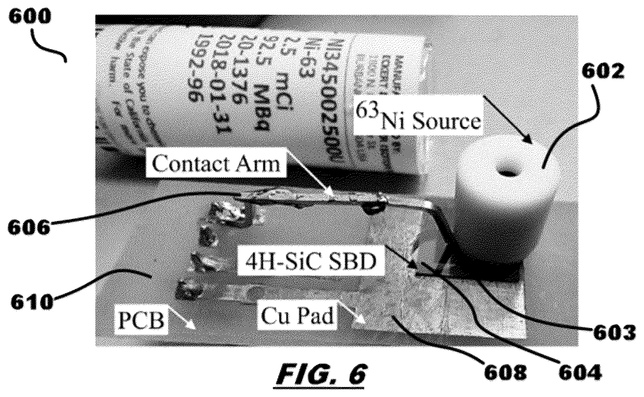

For the betavoltaic measurements, a 2.5 mCi ⁶³Ni beta emitting radioisotope was placed directly on top of the gate contact on the MOS device. The radioisotope used was a foil source lining the inner surface of a ceramic cylinder. The source-device assembly is shown in FIG. 6. J-V characteristics were recorded with and without the MOS device exposed to the beta source. Because of the presence of the- anode arm and the cylindrical form of the beta source, the gate contact was partially illuminated by the beta particles. FIG. 6 shows a photograph of a Ni/Y₂O₃/4H—SiC MOS betavoltaic cell source assembly 600. The cylindrical ⁶³Ni beta source 602 has been placed directly on the top of the gate contact 603 of the cell 604. The source covered the gate contact partially because of the obstruction from the contact arm 606. Cell 604 was place on a copper pad 608 attached to a printed circuit board 610 with contact arm 606 contacting cell 604 as well as affixed to printed circuit board 610.

### Results and Discussions

### Electrical Characterization of the MOS Devices

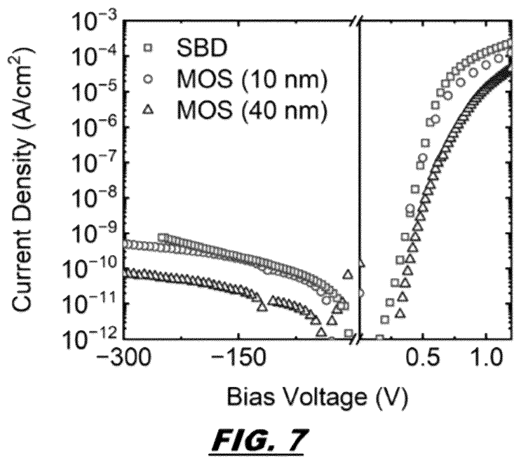

FIG. 7 shows the semilogarithmic J-V characteristics of two Ni/Y2O3/4H—SiC MOS devices with 10 and 40 nm thick Y2O3layers along with that obtained from a Ni/4H—SiC Schottky barrier device (SBD) for comparison. The 4H—SiC epilayers in all the devices were 20 lm thick and derived from a single parent wafer. The highly asymmetric nature of the J-V curves with respect to the bias polarity implies the excellent rectification behavior of the devices. FIG. 7 shows the dark current density-voltage (J-V) characteristics for the MOS device with 40 nm thick oxide layer compared with those obtained from a MOS device with 10 nm thick oxide layer and a Ni/4H—SiC SBD. The linear region on the positive gate bias characteristic was fitted with a thermionic emission model to obtain the junction parameters.

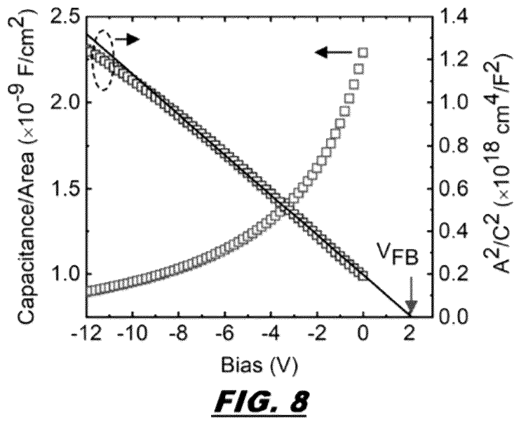

The positive gate bias (forward bias for the SBD) shows a linear region implying thermionic emission modeled as Eq. 2 below. See, S. M. Sze, K. K. Ng, Physics of Semiconductor Devices (Wiley, New Jersey, 2007).

$$J = {A}^{*} {T}^{2} exp ( - \frac{q {Φ}_{B}}{{k}_{B} T} ) [ exp ( \frac{qV}{{nk}_{B} T} ) - 1 ] \qquad ( 2 )$$

where A* is the effective Richardson constant (146 A/cm²/K²), T is the absolute temperature of the junction, q is the elementary charge of an electron, Φ_{B} is the barrier height, k_{B} is the Boltzmann's constant, and n is the ideality factor. A straight line fit to the linear regions in the positive gate bias region revealed diode ideality factors of 1.02 for the SBD, and 1.07 and 1.01 for the MOS detectors with 10 and 40 nm thick Y2O3 layer, respectively. Apart from the indication that electron transport is in conformity to ideal diode behavior, an ideality factor close to unity in large area diodes, such as those used in this work, also implies that there exists a high degree of spatial uniformity of the barrier height across the contact area. See, R. T. Tung, The physics and chemistry of the Schottky barrier height. Appl. Phys. Rev. 1, 011304 (2014). doi.org/10.1063/1.4858400. The transition to the flatter region beyond the linear region in the positive semilogarithmic J-V characteristics presented in FIG. 8 is due to the device series resistance. The effect of the series resistance was seen to be higher in the MOS compared to the SBD and even higher in the MOS with the thicker (40 nm) Y2O3 layer, which is evident from the fact that the measured current at any given positive bias is highest in the SBD and least in the MOS detector with the thicker oxide layer. A higher series resistance in photovoltaic cells reduces the fill factor and results in lowering the conversion efficiency. See, A. LaPotin, K. L. Schulte, M. A. Steiner, K. Buznitsky, C. C. Kelsall, D. J. Friedman, E. J. Tervo, R. M. France, M. R. Young, A. Rohskopf, S. Verma, E. N. Wang, A. Henry, Thermophotovoltaic efficiency of 40%. Nature 604, 287-291 (2022). doi.org/10.1038/s41586-022-04473-y. Although the MOS device with 40 nm thick Y2O3 layer showed higher series resistance, the dark current in the negative bias region was observed to be an order of magnitude lower than that observed in the MOS with the 10 nm thick Y2O3 layer. The dark current of the thicker oxide layer device was measured to be two orders of magnitude lower than that observed in the SBD. The additional barrier height introduced by the Y2O3 layer (low junction current) and the effect of surface passivation (low surface current) are primarily responsible for the reduction in the overall dark current in the MOS devices compared to the SBD. See, S. K. Chaudhuri supra. The MOS device with the thicker (40 nm thick) Y2O3 layer demonstrated lower leakage current compared to the one with the 10 nm Y2O3 layer likely due to the lower tunneling current. FIG. 8 shows the capacitance (per unit area)-voltage characteristics obtained for a Ni/Y₂O₃/4H—SiC MOS device with 40 nm thick oxide layer recorded using a test frequency of 1 MHz. The corresponding Mott-Schottky plot has been plotted on the right y axis. The solid line is a linear fit to the Mott-Schottky plot.

Dark current is one of the most important device parameters that decide the overall efficiency of a photo-/radiovoltaic cell. Hence, it was decided to study the radiovoltaic properties of the Ni/Y2O3/4H—SiC MOS devices with 40 nm thick Y2O3 layer. Further, it will be shown that the minority carrier diffusion length was longer by a factor of 2 in the MOS device with the thicker Y2O3 layer. Another important parameter that enhances the cell efficiency is the built-in (SBD) or the flat-band (MOS) potential. It arises due to the internal electric field that resists diffusion of electrons from the epilayer side to the metal side under equilibrium condition.

Under the quasi-equilibrium condition of excess electron-hole pairs generated by the incident radiation, this internal field assists the holes that reach the depletion edge in the 4H—SiC epilayer to drift toward the gate resulting in high minority carrier (hole) charge collection efficiency (see FIG. 5). FIG. 8 shows the C-V characteristics measured in a Ni/Y2O3/4H—SiC MOS device with 40 nm thick Y2O3 layer. The corresponding Mott-Schottky (1/C² vs V) plot is also shown in FIG. 8. A voltage-axis intercept of the linear fit to the Mott-Schottky plot according to a parallel plate capacitor model given by Eq. 3 below gives the flat-band potential which in this case was calculated to be 2.1 V, see S. M. Sze supra.

$$\frac{1}{{C}^{2}} = \frac{2}{{ϵ}_{4 H - SiC} {ϵ}_{0} {qN}_{eff}} ( V - {V}_{FB} ) \qquad ( 3 )$$

In the above equation, q is the electronic charge, ε0 is the electrical permittivity of vacuum, and ε4H SiC is the dielectric constant of 4H—SiC, and Neff is the effective doping concentration of the 4H—SiC epilayer.

### Minority Carrier Diffusion Length

The flat-band potential results in the formation of a narrow depletion width in the 4H—SiC epilayer even at 0 V applied bias which in this case was calculated to be ≈3.8 lm. The depletion width xd has been calculated as x_{d}=\sqrt{2·.ϵ_{4H—SiC}·ϵ₀·N_{eff}·V_{FB}/q}. Most incident radiation transmits through this depletion width and generates the charge pairs in the neutral region (undepleted epilayer thickness). The charge pairs diffuse through the neutral region and a fraction of them reaches the inside edge of the depletion width. The minority carriers see an attractive potential at this location, which helps them to drift across the depletion width generating a radiocurrent. To achieve a considerable radiocurrent (substantially higher than the reverse leakage/dark current), it is required that a large number of minority carriers reach the depletion edge, and a high built-in potential is established across the depletion width. The number of minority carriers that reach the depletion edge from their point of creation depends on the minority carrier diffusion length, which is defined as the average distance a minority carrier travels before it recombines. The minority carrier diffusion length can be calculated using a drift-diffusion model that predicts the variation of charge collection efficiency (ntheory) as a function of applied bias in Schottky type junctions. Equation 4 given below describes the drift-diffusion model, see K. C. Mandal and M. B. H. Breese, A theory of ion beam induced charge collection. J. Appl. Phys. 74(6), 3789-3799 (1993). doi.org/10.1063/1.354471.

$${η}_{theory} = \frac{1}{{E}_{i}} \{ {\int }_{0}^{{x}_{d}} ( \frac{dE}{dx} ) dx + {\int }_{{d}_{x}}^{{d}_{r}} ( \frac{dE}{dx} ) esxp [ - \frac{x - {x}_{d}}{{L}_{d}} ] dx \} \qquad ( 4 )$$

In the above equation, dE/dx is the stopping power of the alpha particles in 4H—SiC calculated using SRIM-2008, see J. F. Ziegler, M. D. Ziegler, J. P. Biersack, SRIM—the stopping and range of ions in matter. Nucl. Instrum. Meth. Phys. Res. B 268(11-12), 1818-1823 (2010). //doi.org/10.1016/j.nimb.2010.02.091, x is the distance measured from the metal-semiconductor interface, xd is the depletion width at a given bias, xr is the range of the particle, and Ld is the minority carrier diffusion length.

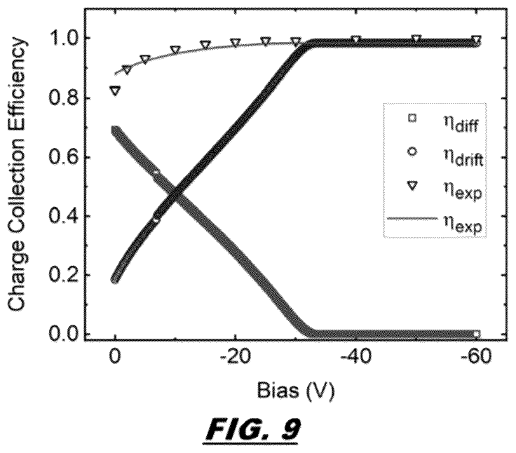

FIG. 9 shows the variation of the charge collection efficiency (ηₑₓₚ) in the Ni/Y2O3/4H—SiC MOS device with 40 nm thick Y2O3 epilayer as a function of negative gate bias. The ηₑₓₚ were calculated from the experimentally obtained PHS with the MOS device configured as a radiation detector and exposed to a ²⁴¹Am source emitting alpha particles primarily with an energy Ei=5486 keV. The position of the peak in the pulse height spectrum (Edet) corresponding to alpha particles with energy Ei is the energy detected by the detector. Edet is much lower than Ei at lower voltages due to the incomplete charge collection. The charge collection efficiency ηₑₓₚ is calculated as the ratio Edet/Ei. The charge collection efficiency approaches 1 at higher bias when all the charge pairs created by the incident radiation are collected by the detector. The variation of ηₑₓₚ with bias was fitted to Eq. 4 with Ld as a fitting parameter. FIG. 9 shows the variation of CCE (triangles), measured with the Ni/Y₂O₃/4H—SiC MOS device configured as a radiation detector exposed to a ²⁴¹Am α-source, with negative gate bias. The contribution of charge carrier diffusion (square) toward the collection efficiency was observed to dominate over that from the charge carrier drift in the lower gate bias region. The solid line is the theoretical fit to the experimentally observed CCE values according to a drift-diffusion model of charge transport (Eq. 4).

The best fit yielded Ld=52.2 lm for the MOS device. The calculated hole diffusion length is much higher than that observed in the SBD and the MOS with 10 nm thick Y2O3 epilayer which were calculated to be 22.8 and 27.6 lm, respectively. Such high diffusion length implies a high charge collection efficiency in the radiovoltaic mode. Indeed, the charge collection efficiency at 0 V applied bias was observed to be 0.82 for the MOS device with 40 nm thick Y2O3 epilayer, which is much higher compared to the 0.70 and 0.69 obtained for the MOS device with 10 nm thick Y2O3 epilayer and the SBD, respectively.

### Radiovoltaic Characterization

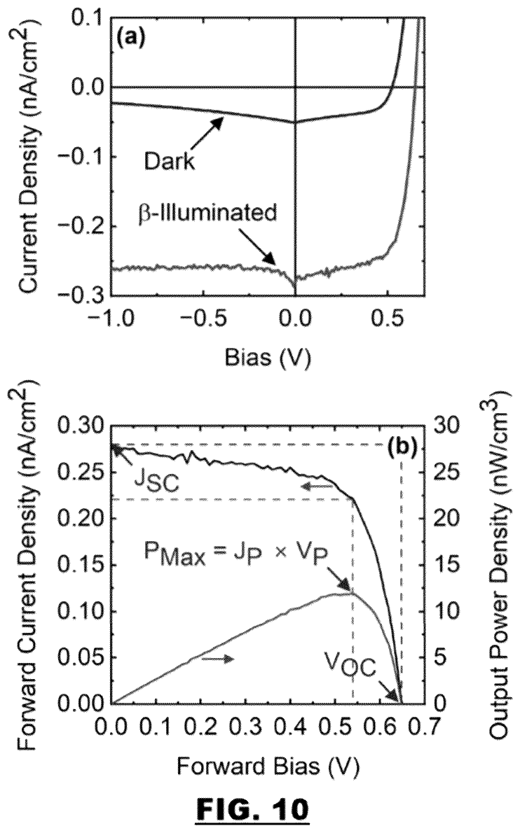

FIG. 10 shows the variation of radiocurrent as a function of gate bias when the Ni/Y2O3/4H—SiC MOS device with 40 nm thick Y2O3 epilayer exposed to a ⁶³Ni beta source. The dark current variation has also been shown in the plot. The performance of the betavoltaic cells is quantized in terms of parameters similar to those used for photovoltaic cells. See, C. Zhao, F. Liao, K. Liu, Y. Zhao, Breaking the myth: widebandgap semiconductors not always the best for betavoltaic batteries. Appl. Phys. Lett. 119, 153904 (2021). https://doi.org/10.1063/5.0068269 and C. Zhao, L. Lei, F. Liao, D. Yuan, Y. Zhao, Efficiency prediction of planar betavoltaic batteries basing on precise modeling of semiconductor units. Appl. Phys. Lett. 117, 263901 (2020). doi.org/10.1063/5.0033052.

The open circuit voltage VOC, defined as the maximum voltage available from the cell at zero current when illuminated; the short circuit current density JSC, defined as the current density through the junction at zero bias; and the fill factor (FF), defined as the ratio of maximum output power Pmax and the product V_{OC}×JSC, were calculated to characterize the betavoltaic cell. The maximum power is obtained by differentiating the power-voltage curve as shown in FIG. 10 at (b). FIG. 10 at (b) shows the variation of the radiocurrent and the output power density as a function of the positive gate bias. The FF was calculated to be 66% even though the gate contact partially exposed to the source. The FF in this device is anticipated to be much higher when the entire gate is illuminated. The JSC and the VOC were calculated to be 0.28 nA/cm2 and 0.65 V, respectively. Considering the thickness of the epilayer as the cell thickness, the output power density was calculated to be 11 nW/cm³ (with partial illumination). Although the output power seems modest compared to solar photovoltaics, several radiovoltaic cells can be connected in parallel to produce a sizeable output power. Parallelly connected 200 diamond Schottky diodes with unenriched ⁶³Ni source have been recently reported to provide a fill factor of 70% and an output power density of 10 μWcm⁻³, which is high enough to power a cardiac pacemaker. See, V. S. Bormashov, S. Y. Troschiev, S. A. Tarelkin, A. P. Volkov, D. V. Teteruk, A. V. Golovano, M. S. Kuznetsov, N. V. Kornilov, S. A. Terentiev, V. D. Blank, High power density nuclear battery prototype based on diamond Schottky diodes. Diamond Relat. Mater. 84, 41-47 (2018). doi.org/10.1016/j.diamond.2018.03.006. Among the present 4H—SiC betavoltaic cells, a fill factor of 86% has been reported with a conversion efficiency of 18.6% using tritium foil sources which is still lower than the theoretical conversion efficiency ηₜₕ predicted to be around 25% as per the Klein's relation. See, C. A. Klein supra. From the known activity of the source and the measured β-counts above noise, we are able to estimate the tritium detection efficiency. The Ni/4H—SiC MOS device with a 20 lm thick 4H—SiC converter discussed herein has shown much higher charge collection efficiency of 82% at 0 V applied bias and hence is suitable for a variety of beta sources emitting beta particles in a much wider energy range.

### Conclusions

The trends over the past decade have shown a gradual but marginal increase in the overall efficiency of 4H—SiC betavoltaic cells, and no major increase in power densities has been reported so far. Herein, a novel Ni/Y2O3/4H—SiC vertical heteroepitaxial MOS device with excellent hole transport property and extremely high charge collection efficiency has been characterized for betavoltaic properties. The 20 lm thick n-type 4H—SiC epitaxial layer in the device acted as the converter material. The 4H—SiC layers used for the device fabrication were highly crystalline and had ultralow concentration of micro- and macro-crystal defects.

The pulsed laser deposited high-k Y2O3 epitaxial layer offered a two-fold advantage. It helped to reduce the dark current substantially compared to that observed in Schottky barrier diodes fabricated on similar 4H—SiC epilayers and passivated the 4H—SiC surface thereby reducing the surface recombination velocity. The devices produced a robust radiocurrent signal and demonstrated a maximum power density output of 11 nW/cm³ and a fill factor of 66% when exposed to a 2.5 mCi ⁶³Ni beta particle emitter. The cylindrical form of the beta source allowed only a fraction of the emitted beta particles to reach the device. Further, the electrode contact configuration in the present work allowed only partial illumination of the device active area. The observed output power density is comparable to that reported for a single betavoltaic cell in diamond betavoltaic battery. The results indicate that the performance of the MOS radiovoltaic cells is expected to improve substantially under full illumination and a flat foil beta source.

Further, these MOS betavoltaic cells have shown much higher charge collection efficiency at 0 V applied bias and showing higher fill factor with much thinner converter layers (200 nm) whose usage is limited to low energy beta sources only. The betavoltaic measurement results obtained using the present Ni/Y2O3/4H—SiC vertical heteroepitaxial MOS betavoltaic cells for harsh environment applications have shown high prospect to offer a conversion efficiency approaching the theoretically predicted maximum conversion efficiency and higher output power than the commercial betavoltaic cells. As a future work, we plan to modify the design of the betavoltaic cell to allow for complete illumination and calculate the conversion efficiency.

The current disclosure further provides a high photocurrent-to-dark current ratio (PDCR) of 8×10⁵ observed in Mo/4H—SiC Schottky barrier diodes (SBDs) in self-biased mode when exposed to a 1.5 mW ultraviolet (UV) emitting at 365 nm. Such high performing self-biased UV photodetectors are poised to address the longstanding problem of designing self-powered UV sensors for harsh environment applications e.g., advanced nuclear reactors and space missions. The vertical Schottky diodes have been fabricated by depositing semi-transparent molybdenum anode contact on 20 μm thick n-type 4H—SiC epilayer with an effective doping concentration of 10¹⁴ cm⁻³ and low trap concentration.

The SBDs demonstrated a built-in voltage (V_{bi}) of 2.48 V as measured from capacitance-voltage characteristics with a test frequency of 1 MHz. A hole diffusion length (L_{d}) of 22.8 μm was calculated using a drift-diffusion model applied to alpha radiation response of the SBDs. Such high V_{bi} and L_{d} led to an excellent charge collection efficiency of 70% and the large PDCR at 0 V applied bias (self biased mode). The results presented herein reveal the unexplored potential of wide bandgap semiconductors as high-efficiency self-biased UV photodetectors.

Development of scintillator materials that can sustain high temperatures and radiation background is on the rise as there is a high demand in field applications such as monitoring radiation near nuclear reactor cores, in high energy astrophysics, medical imaging, and nuclear non-proliferation. See, Y. Saito, S. Gunji, T. Nakamori, T. Mihara, D. Yonetoku, T. Sawano, S. Kurosawa, and S. Kodaira, “Irradiation tests of silicon photomultipliers for use in space,” IEEE Trans. Nucl. Sci., vol. 70, no. 2, pp. 150-155, February 2023, doi: 10.1109/TNS.2022.3162788, J. D. Wrbaneck and S. Y. Wrbaneck, “Space radiation and impact on instrumentation technologies,” Glenn Res. Center, Cleveland, Ohio, USA, Tech. Rep. NASA/TP-2020-220002, January 2020, and Y. Xu, Y. Qi, Q. Qian, J. Chen, Z. Yang, and K. Wang, “Backside illuminated 3-D photosensitive thin-film transistor on a scintillating glass substrate for indirect-conversion X-ray detection,” IEEE Electron Device Lett., vol. 41, no. 8, pp. 1209-1212, August 2020, doi:10.1109/LED.2020.3001922. Most scintillators that detect high energy gamma rays with prompt timing response, emit in the ultraviolet region. See, C. Piemonte, F. Acerbi, A. Ferri, A. Gola, G. Patrnoster, V. Regazzoni, G. Zappala, and N. Zorzi, “Performance of NUV-HD silicon photomultiplier technology,” IEEE Trans. Electron Devices, vol. 63, no. 3, pp. 1111-1116, March 2016, doi: 10.1109/TED.2016.2516641. The primary bottleneck in the application of scintillator detectors in harsh environments is the lack of availability of UV photodetectors or photomultiplier tubes (PMTs) that can detect the scintillating UV radiations and withstand high temperatures and radiation background. See, A. Datta, R. Toufanian, W. Zhang, P. S. Halasyamani, and S. Motakef, “Radiation hard gallium oxide scintillators for high count rate radiation detection,” Opt. Mater., vol. 134, December 2022, Art. no. 113115, doi:10.1016/j.optmat.2022.113115, and P. Bhattacharya, C. Brown, C. Sosa, M. Wart, S. Miller, C. Brecher, and V. V. Nagarkar, “Tl2 ZrCl6 and Tl2 HfCl6 intrinsic scintillators for gamma rays and fast neutron detection,” IEEE Trans. Nucl. Sci., vol. 67, no. 6, pp. 1032-1034, June 2020, doi: 10.1109/TNS.2020.2997659. As PMTs require high operating voltages and are incompatible with radioimaging modalities such as magnetic resonance imaging (MRI) where strong magnetic fields are involved, compact semiconductor UV sensors will be most appropriate. See, S. Kasap and Z. Kabir, “X-ray detectors,” in Springer Handbook of Semiconductor Devices, M. Rudan, R. Brunetti, and S. Reggiani, Eds. Cham, Switzerland: Springer, 2022, pp. 747-776.

The 4H polytype of silicon carbide or 4H—SiC is a wide bandgap (3.27 eV) semiconductor that is radiation hard, UV sensitive, solar blind, chemically inert, and mechanically robust. See, S. K. Chaudhuri and K. C. Mandal, “Radiation detection using n-type 4H—SiC epitaxial layer surface barrier detectors,” in Advanced Materials for Radiation Detection, K. Iniewski, Ed. Cham, Switzerland: Springer, August 2022, pp. 183-209, I. Capan, T. Brodar, R. Bernat, Z̆. Pastuović, T. Makino, T. Ohshima, J. D. Gouveia, and J. Coutinho, “M-center in 4H—SiC: Isothermal DLTS and first principles modeling studies,” J. Appl. Phys., vol. 130, no. 12, September 2021, Art. no. 125703, doi: 10.1063/5.0064958, and J. W. Kleppinger, S. K. Chaudhuri, O. Karadavut, R. Nag, D. L. P. Watson, D. S. McGregor, and K. C. Mandal, “Deep-level transient spectroscopy and radiation detection performance studies on neutron irradiated 250-μm-thick 4H—SiC epitaxial layers,” IEEE Trans. Nucl. Sci., vol. 69, no. 8, pp. 1972-1978, August 2022, doi:10.1109/TNS.2022.3168789. Epitaxial 4H—SiC wafers are highly crystalline and substantially cheaper than other harsh environment compatible wide bandgap semiconductors like single crystalline diamond. See, J.-C. Arnault, S. Saada, and V. Ralchenko, “Chemical vapor deposition single-crystal diamond: A review,” Phys. Status Solidi, Rapid Res. Lett., vol. 16, no. 1, January 2022, Art. no. 2100354, doi:10.1002/pssr.202100354. 4H—SiC electronic devices and sensors have demonstrated very high breakdown voltages and are operable at extremely high temperatures for prolonged periods. See, C. S. Bodie, G. Lioliou, and A. M. Barnett, “Hard X-ray and γ-ray spectroscopy at high temperatures using a COTS SiC photodiode,” Nucl. Instrum. Methods Phys. Res. A, Accel. Spectrom. Detect. Assoc. Equip., vol. 985, January 2021, Art. no. 164663, doi: 10.1016/j.nima.2020.164663, J. W. Kleppinger, S. K. Chaudhuri, O. Karadavut, and K. C. Mandal, “Role of deep levels and barrier height lowering in current-flow mechanism in 150 μm thick epitaxial n-type 4H—SiC Schottky barrier radiation detectors,” Appl. Phys. Lett., vol. 119, no. 6, August 2021, Art. no. 063502, doi: 10.1063/5.0064036, P. G. Neudeck, D. J. Spry, L. Chen, N. F. Prokop, and M. J. Krasowski, “Demonstration of 4H—SiC digital integrated circuits above 800° C.,” IEEE Electron Device Lett., vol. 38, no. 8, pp. 1082-1085, August 2017, doi: 10.1109/LED.2017.2719280, and S. Das, T. Isaacs-Smith, A. Ahyi, M. A. Kuroda, and S. Dhar, “High temperature characteristics of nitric oxide annealed p-channel 4H—SiC metal oxide semiconductor field effect transistors,” J. Appl. Phys., vol. 130, no. 22, December 2021, Art. no. 225701, doi: 10.1063/5.0073523. The wide bandgap, high melting point (>3000 K), high thermal conductivity (490 W/m/K), high atomic displacement threshold (66 eV for Si and 24 eV for C), high breakdown electric field (10³ kV/cm), and excellent charge transport properties make 4H—SiC the next generation electronic material for harsh environment applications. See, T. Kimoto and J. A. Cooper, Fundamentals of Silicon Carbide Technology: Growth, Characterization, Devices and Applications. Singapore: Wiley, September 2014, pp. 521-524, G. Lucas and L. Pizzagalli, “Ab initio molecular dynamics calculations of threshold displacement energies in silicon carbide,” Phys. Rev. B, Condens. Matter, vol. 72, no. 16, October 2005, Art. no. 161202, doi:10.1103/PhysRevB.72.161202, and K. C. Mandal, J. W. Kleppinger, and S. K. Chaudhuri, “Advances in high-resolution radiation detection using 4H—SiC epitaxial layer devices,” Micromachines, vol. 11, no. 3, p. 254, February 2020, doi:10.3390/mi11030254.

4H—SiC readily forms highly stable Schottky barrier diodes (SBDs) with many metals and demonstrate high built-in potential. See, S. K. Chaudhuri, K. J. Zavalla, and K. C. Mandal, “High resolution alpha particle detection using 4H—SiC epitaxial layers: Fabrication, characterization, and noise analysis,” Nucl. Instrum. Methods Phys. Res. A, Accel. Spectrom. Detect. Assoc. Equip., vol. 728, pp. 97-101, November 2013, doi: 10.1016/j.nima.2013.06.076. These properties have been utilized to fabricate nuclear radiation detectors with high charge collection efficiency and excellent energy resolution in self-biased mode. See, S. K. Chaudhuri, O. Karadavut, J. W. Kleppinger, R. Nag, G. Yang, D. Lee, and K. C. Mandal, “Enhanced hole transport in Ni/Y₂O₃/n-4H—SiC MOS for self-biased radiation detection,” IEEE Electron Device Lett., vol. 43, no. 9, pp. 1416-1419, September 2022, doi:10.1109/LED.2022.3188543. Nickel (Ni) with a work function of ≈5.22 eV has been the standard choice as the Schottky contact in n-type 4H—SiC for demonstrating very high barrier height, low contact resistivity, high thermal stability, and reproducibility. See, S. Y. Han, J.-Y. Shin, B.-T. Lee, and J.-L. Lee, “Microstructural interpretation of Ni ohmic contact on n-type 4H—SiC,” J. Vac. Sci. Technol. B, Nanotechnol. Microelectron, vol. 20, pp. 1496-1500, July/August 2002, doi: 10.1116/1.1495506. Molybdenum (Mo) is yet another refractory contact metal appropriate to achieve Schottky barrier devices for harsh environment applications. See, K.-H. Chen, F. Cao, Z.-Y. Yang, X.-J. Li, J.-Q. Yang, D.-K. Shi, and Y. Wang, “Improved interface characteristics of Mo/4H—SiC Schottky contact,” Solid-State Electron., vol. 185, November 2021, Art. no. 108152, doi: 10.1016/j.sse.2021.108152, J. Hong, K. H. Kim, and K. H. Kim, “Rectifying characteristics of thermally treated Mo/SiC Schottky contact,” Coatings, vol. 9, no. 6, p. 388, June 2019, doi: 10.3390/coatings9060388, and Z. Ouennoughi, S. Toumi, and R. Weiss, “Study of barrier inhomogeneities using I-V-T characteristics of Mo/4H—SiC Schottky diode,” Phys. B, Condens. Matter, vol. 456, pp. 176-181, January 2015, doi:10.1016/j.physb.2014.08.031. Mo/4H—SiC SBDs, despite offering lower barrier height, demonstrates higher efficiency, reduced threshold voltage, and lower Ohmic losses due to the lower work function of Mo (≈4.53 eV). See, G. Lioliou, A. B. Renz, V. A. Shah, P. M. Gammon, and A. M. Barnett, “Mo/4H—SiC Schottky diodes for room temperature X-ray and γ-ray spectroscopy,” Nucl. Instrum. Methods Phys. Res. A, Accel. Spectrom. Detect. Assoc. Equip., vol. 1027, March 2022, Art. no. 166330, doi:10.1016/j.nima.2022.166330, R. Rupp, R. Elpelt, R. Gerlach, R. Schomer, and M. Draghici, “A new SiC diode with significantly reduced threshold voltage,” in Proc. 29th Int. Symp. Power Semiconductor Devices IC's (ISPSD), Sapporo, Japan, May 2017, pp. 355-358, doi: 10.23919/ISPSD.2017.7988991.

Despite the superior material and device properties, the potential of self-biased UV detectors fabricated from present day low-defect 4H—SiC epitaxial layer has not been explored yet. Here, we demonstrate for the first time the response- of self-biased Mo/4H—SiC Schottky photodetectors as compact ultraviolet photovoltaic cells in harsh environment applications where most conventional semiconductors fail.

### Experimental Methods

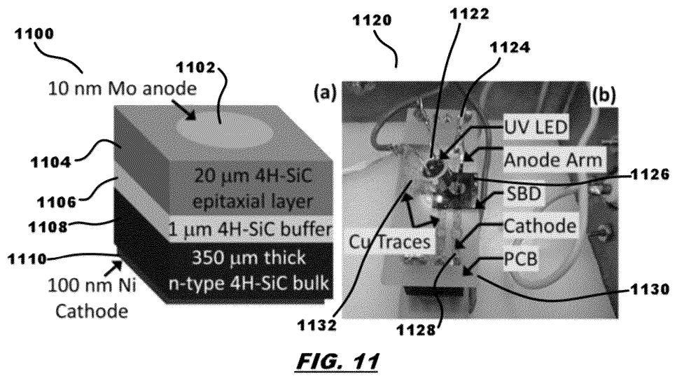

Detector grade 20 μm thick n-type 4H—SiC epitaxial layers were grown on the (0001) Si face of a highly conducting (≈0.02 Ω-cm) n-type 4H—SiC substrate by hot-wall chemical vapor deposition. See, J. W. Kleppinger, S. K. Chaudhuri, O. Karadavut, R. Nag, and K. C. Mandal, “Influence of carrier trapping on radiation detection properties in CVD grown 4H—SiC epitaxial layers with varying thickness up to 250 μm,” J. Cryst. Growth, vol. 583, April 2022, Art. no. 126532, doi: 10.1016/j.jcrysgro.2022.126532. The 350 μm thick substrate surface was 4° off-cut towards the [1120] direction to reduce surface defects. The epilayers were grown on substrates with an aerial micropipe defect (MPD) density <1 cm⁻² and the epilayers itself have Z1/2 and EH5 trap concentration on the order of 1012 cm−3. See, O. Karadavut, S. K. Chaudhuri, J. W. Kleppinger, R. Nag, and K. C. Mandal, “Effect of oxide layer growth conditions on radiation detection performance of Ni/SiO2/epi-4H—SiC MOS capacitors,” J. Cryst. Growth, vol. 584, April 2022, Art. no. 126566, doi:10.1016/j.jcrysgro.2022.126566. No traces of the EH6/7 point defects had been observed. Carbon vacancy related traps like Z1/2 and EH6/7 and extended defects like MPDs are the ones that affect the charge transport in 4H—SiC the most. See, T. Kimoto, K. Danno, and J. Suda, “Lifetime-killing defects in 4H—SiC epilayers and lifetime control by low-energy electron irradiation,” Phys. Status Solidi B, vol. 245, no. 7, pp. 1327-1336, June 2008, doi:10.1002/pssb.200844076, and J. J. Sumakeris, J. R. Jenny, and A. R. Powell, “Bulk crystal growth, epitaxy, and defect reduction in silicon carbide materials for microwave and power devices,” MRS Bull., vol. 30, pp. 280-286, April 2005, doi:10.1557/mrs2005.74. The epilayer wafers were diced into 8 mm×8 mm specimens for device fabrication. The specimens were cleaned using a standard RCA procedure followed by removal of the native oxide layer using a 10% diluted aqueous HF solution. See, W. Kern, “The evolution of silicon wafer cleaning technology,” J. Electrochem. Soc., vol. 137, no. 6, pp. 1887-1892, June 1990, doi:10.1149/1.2086825. Circular shaped (ø=3.9 mm) thin (10 nm) molybdenum (Mo) contacts were sputter coated on the silicon side of the epilayer to form the Schottky barrier contact. Such thin metal windows are almost transparent to the incident radiation as they offer minimal energy loss and yet form stable electrical contacts. A square (6 mm×6 mm) shaped 80 nm thick nickel was deposited on the bulk side of the 4H—SiC wafer to form the back Ohmic contact. The schematic of the detector structure has been shown in FIG. 11. FIG. 11 shows at (a) a schematic diagram of the Mo/n-4H—SiC epitaxial SBD structure. SBD structure 1100 may include a molybdenum anode 1102, 4H—SiC epitaxial layer 1104 over a 4H—SiC buffer layer 1106, this over an n-type 4H—SiC bulk layer 1108, with an underlying nickel cathode 1110. FIG. 11 at (b) shows a photograph of an 8 mm×8 mm detector 1120 mounted on a printed circuit board (PCB) 1130 exposed to an UV LED 1122 along with an anode arm 1124, SBD structure 1126, cathode 1128 and copper traces 1132.

Alpha spectroscopic measurements were carried out in a benchtop spectrometer with the detectors connected to a CR110 preamplifier and exposed to a 0.9 μCi ²⁴¹Am radioisotope emitting 5486 keV alpha particles. See, O. Karadavut, S. K. Chaudhuri, J. W. Kleppinger, R. Nag, and K. C. Mandal, “Enhancement of radiation detection performance with reduction of EH6/7 deep levels in n-type 4H—SiC through thermal oxidation,” Appl. Phys. Lett., vol. 121, no. 1, July 2022, Art. no. 012103, doi: 10.1063/5.0089236. The UV response was investigated by recording the current-voltage (I-V) characteristics using a Keithley 237 source-measure unit

(SMU) under dark and under illumination when exposed to a Marktech Optoelectronics MT3650N3-UV 1.5 mW ultraviolet (UV) light emitting diode emitting at 365 nm with a spectral line half width of 15 nm. A photograph of the UV illumination of the detector mounted on a PCB has been shown in FIG. 11 at b.

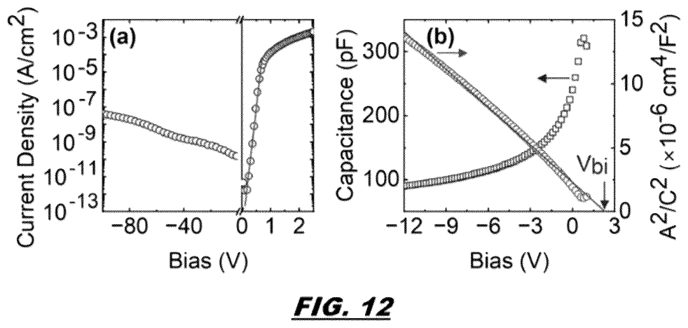

The variation of the dark current density (J) as a function of the forward (positive) and reverse (negative) bias (V) measured at room temperature using the Keithley 237 SMU has been shown in FIG. 12. FIG. 12 shows at (a) a graph of variation of current density with bias for a Mo/4H—SiC epitaxial SBD. The solid line is the linear fit according to Eq. 5 (b) C-V characteristic (left y-axis) and the Mott-Schottky plot (A²/C² vs V, A being the anode area, right y-axis). The solid line shows the linear fit to the Mott-Schottky plot according to Eq. 6. The J-V characteristics showed high degree of rectification confirming fabrication of high quality Schottky diodes. The linear portion in the forward-bias region has been fitted with a thermionic emission model (Eq. 5) which revealed a Schottky barrier height of 1.06 eV and a diode ideality factor of 1.02. See, M. J. Tadjer, K. D. Hobart, T. J. Anderson, T. I. Feygelson, R. L. Myers-Ward, A. D. Koehler, F. Calle, C. R. Eddy, D. K. Gaskill, B. B. Pate, and F. J. Kub, “Thermionic-field emission barrier between nanocrystalline diamond and epitaxial 4H—SiC,” IEEE Electron. Dev. Lett., vol. 35, no. 12, pp. 1173-1175, Deember. 2014, doi:10.1109/LED.2014.2364596.

$$J = {A}^{*} {T}^{2} ( {e}^{- {φ}_{B} / {k}_{B} T} ) ( {e}^{\frac{V}{{nk}_{B} T}} - 1 ) \qquad ( 5 )$$

In the above equation A* is the effective Richardson constant (146 Acm⁻2 K⁻² for 4H—SiC), φ_{B} is the Schottky barrier height, n is the diode ideality factor, k_{B} is the Boltzmann constant, and T is the absolute temperature. The observed barrier height is lower than that obtained in our Ni-based SBDs due to the lower work-function of Mo. See, H. B. Michaelson, “The work function of the elements and its periodicity,” J. Appl. Phys., vol. 48, no. 11, pp. 4729-4733, November 1977, doi:10.1063/1.323539. However, a diode ideality factor close to unity ensures highly uniform spatial barrier height distribution across the Mo contact. FIG. 12 at (b) shows the C-V plot obtained using a capacitance meter that uses a test frequency of 1 MHz. The Mott-Schottky plot is also shown on the right y-axis. A linear fit to the Mott-Schottky plot according to the Eq. 6 below revealed an effective doping concentration (N_{eff}) f 1.15×10¹⁴ cm⁻³ and a built-in potential (Vbi) of 2.48 V.

$${A}^{2} / {C}^{2} = \frac{2}{{ε}_{4 H - SiC} {ε}_{0 {qN}_{eff}}} ( V - {V}_{bi} - \frac{{k}_{B} T}{q} ) . \qquad ( 6 )$$

In the above equation, A is the diode area, q is the electronic charge, Co is the electrical permittivity of vacuum, and ε4H—SiC=9.7 is the dielectric constant of 4H—SiC.

Assuming a uniform doping distribution and using the calculated Neff and Vbi values, the depletion width d at zero bias was calculated to be 4.78 μm using Eq. 7 below.

$$d = \sqrt{\frac{2 {ε}_{4 H - SiC} {ε}_{0} {V}_{bi}}{{qN}_{eff}}} . \qquad ( 7 )$$

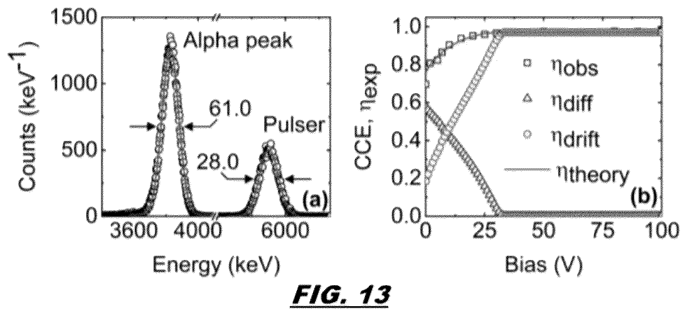

FIG. 13 at (a) shows the pulse height spectrum obtained by the SBD detector without any applied bias when exposed to the ²⁴¹Am source. A robust peak at 3827 keV (detected energy, Eα) corresponding to the 5486 keV alpha particles (incident energy, Ei) with a full width and half maximum (ΔE) of 122 keV implies a very high charge collection efficiency (CCE), ηexp=(Eα/Ei)×100, of ≈70% and a percentage energy resolution ΔEres=ΔE/Eα×100 of ≈3% in self-biased mode. The obtained CCE is much higher compared to the 57% obtained for a Ni/4H—SiC SBD detector with highest energy resolution reported for 5486 keV alpha particles, See, S. K. Chaudhuri and K. J. Zavalla supra. The energy resolution and the CCE improved with bias as expected. The ηexp and ΔEres at an optimized bias of −50 V were calculated to be ≈98% and ≈0.5%. FIG. 13 at (b) shows the variation of the ηexp as a function of the applied reverse bias which has been fitted to the drift-diffusion model. See, M. B. H. Breese, “A theory of ion beam induced charge collection,” J. Appl. Phys., vol. 74, no. 6, pp. 3789-3799, September 1993, doi:10.1063/1.354471. FIG. 13 shows at (a) a graph of pulse height spectrum in self-biased mode obtained using the Mo/4H—SiC SBD exposed to a ²⁴¹Am radioisotope. The solid lines are the Gaussian fit of the peaks. The numbers shown are the FWHM of the peaks in keV. The pulser peak shows the uncertainty in pulse height determination due to the electronic noise. Note that the scale before and after the axis-break are different and at (b) a graph of variation of CCE and its various components as a function of the applied reverse bias. The solid line shows the fitting of ηexp vs V to Eq. 8.

$$\begin{matrix}{η}_{theory} = \frac{1}{{E}_{α}} {\int }_{0}^{{x}_{d}} ( \frac{dE}{dx} ) dx + {\int }_{{x}_{d}}^{{x}_{r}} ( \frac{dE}{dx} ) exp [ - \frac{x - {x}_{d}}{{L}_{d}} ] dx \\ = {η}_{drift} + {η}_{diff} .\end{matrix} \qquad ( 8 )$$

In the above equation, ηtheory is the theoretical CCE, d E/dx is the stopping power of 5486-keV alpha particles in 4H—SiC, xd is the depletion width at a given bias, xr is the range of the alpha particles, and x is the distance within the 4H—SiC epilayer. The first term on right is the CCE in the depletion region due to the drift (ηdrift) and the second term is that due to the diffusion of the charge carriers in the neutral region (ηdiff). The penetration depth of 365 nm photons in 4H—SiC is ≈100 μm which suggests that a major fraction of the photogenerated charge carriers were in the neutral region of the epilayer of the self-biased detector. See, S. G. Sridhara, R. P. Devaty, and W. J. Choyke, “Absorption coefficient of 4H silicon carbide from 3900 to 3250 Å,” J. Appl. Phys., vol. 84, no. 5, pp. 2963-2964, September 1998, doi: 10.1063/1.368403. The minority carrier (hole) diffusion length Ld, calculated to be 22.8 μm from the above fitting, is high enough for most of the holes generated by the incident alpha particles in the neutral region to reach the edge of the depletion width, from where they drift under the action of the built-in potential and are collected by the anode. The high values of Ld and Vbi resulted in the observed high CCE and energy resolution in self-biased mode.

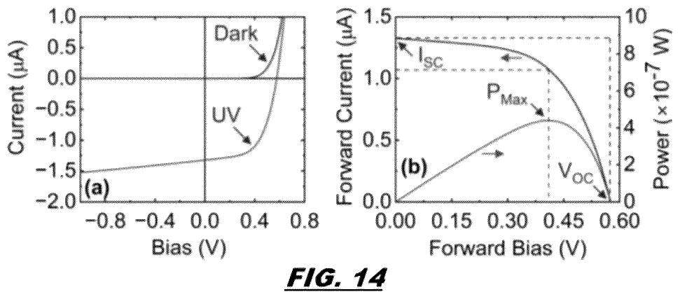

Such superior self-biased performance is highly sought-after in space missions where conventional and solar power supplies are not an option and are also the fundamental requirement of photovoltaic cells. FIG. 14 at (a) shows the variation of dark, and the UV illuminated current as a function of applied bias. FIG. 14 shows at (a) a graph of I-V characteristics under dark and UV (365 nm) illumination of a Mo/4H—SiC SBD and at (b) a graph of forward current (left-y) and the output power (right-y) under UV illumination Being a wide bandgap semiconductor, 4H—SiC is highly efficient in absorbing UV rays making it a suitable candidate for UV detectors. An excellent photocurrent-to-dark current ratio (PDCR) of 8×10⁵ was calculated with the device illuminated by a 1.5 mW LED emitting at 365 nm at 0 V applied bias and measured at room temperature (RT). The long hole diffusion length was instrumental in achieving such high PDCR in the photovoltaic mode. Among the recently reported 4H—SiC UV detectors, Schottky photodiode fabricated with complex interdigitated tungsten electrodes on oxygen plasma pre-treated surface or with WxSiyO1−x−y interlayers reported PDCR values in the range (2.0-5.5)×10⁴ at RT under 275-μm UV illumination and that too when biased within −15 to −25 V. See, F. Du, Q. Song, Z. Zhang, X. Tang, H. Yuan, C. Han, C. Zhang, Y. Zhang, and Y. Zhang, “Fabrication high-temperature 4H—SiC Schottky UV photodiodes by O2 plasma pre-treatment technology,” IEEE Photon. Technol. Lett., vol. 34, no. 17, pp. 911-914, Sep. 1, 2022, doi:10.1109/LPT.2022.3193501 and F. Du, Q. Song, X. Tang, Z. Zhang, H. Yuan, C. Han, C. Zhang, Y. Zhang, and Y. Zhang, “Demonstration of high-performance 4H—SiC MISIM ultraviolet photodetector with operation temperature of 550° C. and high responsivity,” IEEE Trans. Electron Devices, vol. 68, no. 11, pp. 5662-5665, November 2021, doi: 10.1109/TED.2021.3113296. The open-circuit voltage VOC and the short-circuit I_{SC} current calculated from the forward I-V characteristics shown in FIG. 14 at (b) was 0.58 V and 1.33 μA, respectively. See, S. Das, S. K. Chaudhuri, R. N. Bhattacharya, and K. C. Mandal, “Defect levels in Cu2 ZnSn(SxSe1−x)4 solar cells probed by current mode deep level transient spectroscopy,” Appl. Phys. Lett., vol. 104, no. 19, May 2014, Art. no. 192106, doi: 10.1063/1.4876925. The observed UV photovoltaic parameters are orders of magnitude higher than those reported in the previous generation vertical V2O5/4H—SiC SBD operated at room-temperature. See, L. D. Benedetto, G. Landi, G. D. Licciardo, H.-C. Neitzert, and S. Bellone, “Photovoltaic behavior of V₂O₅/4H—SiC Schottky diodes for cryogenic applications,” IEEE J. Electron Devices Soc., vol. 3, no. 5, pp. 418-422, September 2015, doi: 10.1109/JEDS.2015.2451097. The fill factor, FF calculated as PMax/ISC×VOC was found to be 0.57, where PMax, the maximum output power is calculated to be 0.44 μW.

Properties conducive to efficient UV photovoltaic operation in harsh environment has been observed in Mo/n-4H—SiC epitaxial SBDs. The low defect and highly crystalline detector grade epilayers demonstrated a hole diffusion length of 22.8 μm which is longer than the 20 μm thick 4H—SiC epilayer and a built-in potential of 2.48 V that enabled a 70% charge collection efficiency at 0 V applied bias when an SBD was exposed to 5486 keV alpha particles. Such high built-in potential and diffusion length led to a very high PDCR of 8×10⁵ in self-biased mode when the SBD was exposed to a 1.5 mW LED emitting at 365 nm. A maximum power output of 4.4 μW and a fill factor of 0.57 was measured in the photovoltaic mode. The findings presented in this letter implies that such robust, compact, radiation hard, and high-temperature 4H—SiC self-biased UV detector is poised to bridge the technological gap in application of x-/γ-ray scintillators emitting in the UV region, in extreme harsh environments including space missions, medical imaging, nuclear non-proliferation, and homeland security.

Various modifications and variations of the described methods, devices, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features herein before set forth.

What is claimed is:

1. A betavoltaic cell for power generation in harsh environment applications comprising:
at least one metal-oxide-semiconductor comprising:
at least one layer of yttrium oxide pulse laser deposited on at least one n-type 4H—SiC epilayer;
at least one first nickel contact, deposited on the at least one yttrium oxide layer, configured to act as a gate contact; and
at least one second nickel contact formed on the at least one n-type 4H—SiC epilayer as a back contact.

2. The betavoltaic cell of claim 1, wherein the betavoltaic cell is mounted on a printed circuit board.

3. The betavoltaic cell of claim 1, wherein the betavoltaic cell is heteroepitaxial.

4. The betavoltaic cell of claim 1, wherein the betavoltaic cell has reduced dark current as compared to a Schottky barrier diode fabricated on at least one 4H—SiC epilayer.

5. The betavoltaic cell of claim 1, wherein the betavoltaic cell has less surface recombination velocity as compared to a Schottky barrier diode fabricated on at least one 4H—SiC epilayer.

6. The betavoltaic cell of claim 1, wherein the betavoltaic cell has at least a maximum power density output of 11 nW/cm³.

7. The betavoltaic cell of claim 1, wherein the betavoltaic cell has at least a fill factor of 66% when exposed to a 2.5 mCi ⁶³Ni beta particle emitter.

8. The betavoltaic cell of claim 1, wherein the betavoltaic cell further comprises a 4H—SiC buffer layer.

9. The betavoltaic cell of claim 1, wherein the betavoltaic cell further comprises a depletion layer edge.

10. A method for making a betavoltaic cell for power generation in harsh environment applications comprising:
forming at least one vertical metal-oxide-semiconductor via:
growing at least one layer of yttrium oxide, via pulsed laser deposition, on at least one n-type 4H—SiC epilayer;
depositing at least first one nickel contact on the at least one yttrium oxide layer configured to act as a gate contact; and
depositing at least one second nickel contact on the at least one n-type 4H—SiC epilayer to form a back contact.

11. The method for making a betavoltaic cell of claim 10, further comprising mounting the betavoltaic cell on a printed circuit board.

12. The method for making a betavoltaic cell of claim 10, further comprising configuring the betavoltaic cell to be heteroepitaxial.

13. The method for making a betavoltaic cell of claim 10, further comprising configuring the betavoltaic cell to have reduced dark current as compared to a Schottky barrier diode fabricated on at least one 4H—SiC epilayer.

14. The method for making a betavoltaic cell of claim 10, further comprising configuring the betavoltaic cell to have less surface recombination velocity as compared to a Schottky barrier diode fabricated on at least one 4H—SiC pilayer.

15. The method for making a betavoltaic cell of claim 10, further comprising configuring the betavoltaic cell to have at least a maximum power density output of 11 nW/cm³.

16. The method for making a betavoltaic cell of claim 10, further comprising configuring the betavoltaic cell to have at least a fill factor of 66% when exposed to a 2.5 mCi ⁶³Ni beta particle emitter.

17. The method for making a betavoltaic cell of claim 10, further comprising configuring the betavoltaic cell to include a 4H—SiC buffer layer.

18. The method for making a betavoltaic cell of claim 10, further comprising configuring the betavoltaic cell to include a depletion layer edge.
